(19) United States
(12) Patent Application Publication
(10) Pub. No.: US 2024/0349315 A1
(43) Pub. Date: Oct. 17, 2024

(54) SIMULTANEOUS SINGLE-BIT AND MULTI-BIT PHYSICAL SIDELINK FEEDBACK CHANNEL (PSFCH) COMMUNICATION

(71) Applicant: QUALCOMM Incorporated, San Diego, CA (US)

(72) Inventors: Shaozhen GUO, Beijing (CN); Jing SUN, San Diego, CA (US); Changlong XU, Beijing (CN); Xiaoxia ZHANG, San Diego, CA (US); Hao XU, Beijing (CN); Rajat PRAKASH, San Diego, CA (US); Luanxia YANG, Beijing (CN); Siyi CHEN, Beijing (CN)

(21) Appl. No.: 18/700,517

(22) PCT Filed: Dec. 31, 2021
(86) PCT No.: PCT/CN2021/143574

§ 371 Date: Apr. 11, 2024

(51) Int. Cl. H04W 72/40; H04W 72/25; H04W 72/51; H04W 72/566

(52) U.S. Cl. CPC H04W 72/40; H04W 72/25; H04W 72/51; H04W 72/566

(57) ABSTRACT

A sidelink communication method performed by a first user equipment (UE) includes: receiving, from one or more UEs, an indication to transmit a plurality of physical sidelink feedback channel (PSFCH) communications including one or more single-bit PSFCH communications and one or more multi-bit PSFCH communications; and transmitting, to the one or more UEs based on the indication in a single PSFCH occasion, a first number of single-bit PSFCH communications of the one or more single-bit PSFCH communications, and a second number of multi-bit PSFCH communications of the one or more multi-bit PSFCH communications, wherein the first number of single-bit PSFCH communications and the second number of multi-bit PSFCH communications are based on a PSFCH capability configuration.

### TECHNICAL FIELD

This application relates to wireless communication systems, and more particularly to physical sidelink feedback channel (PSFCH) communication among sidelink user equipment devices (UEs).

### INTRODUCTION

To meet the growing demands for expanded mobile broadband connectivity, wireless communication technologies are advancing from the long term evolution (LTE) technology to a next generation new radio (NR) technology, which may be referred to as 5th Generation (5G). In a wireless communication network implementing such wireless communication technologies, communication devices (which may otherwise be known as user equipment (UE)) may communicate with each other via a sidelink. With sidelinks, UEs do not need to tunnel through a base station (BS) or an associated core network.

Sidelink technology has been extended to provision for device-to-device (D2D) communications, vehicle-to-everything (V2X) communications, and/or cellular vehicle-to-everything (C-V2X) communications over licensed bands and/or unlicensed bands. In such communication, a receiving UE may concurrently receive groupcast as well as unicast messages from other UEs (whether both from the same transmitter or from different transmitters). Accordingly, the receiving UE may provide feedback (e.g., physical sidelink feedback channel signals) indicating an acknowledgement and/or non-acknowledgement (ACK/NACK) associated with a sidelink communication, such as a physical sidelink shared channel (PSSCH) communication. PSFCH communications may be communicated in periodic PSFCH occasions. In some instances, there may be multiple PSFCH communications scheduled for a single PSFCH occasion. Further, in some aspects, a sidelink UE may have configurations limiting a number of PSFCH communications that may be communicated in a single PSFCH communication. for individual sessions to the same transmitter or to different transmitters. For example, based on UE PSFCH capabilities, a sidelink UE may not transmit all of the scheduled PSFCH communications in a corresponding PSFCH occasion.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 illustrates a wireless communication network according to some embodiments of the present disclosure.

FIG. 2 illustrates a wireless communication network that provisions for sidelink communications according to some embodiments of the present disclosure.

FIG. 3 illustrates a signaling diagram for a single-bit and multi-bit physical sidelink feedback channel (PSFCH) communication scheme according to some aspects of the present disclosure.

FIG. 4 illustrates a flow diagram for a single-bit and multi-bit PSFCH communication method according to some aspects of the present disclosure.

FIG. 5 illustrates a flow diagram for a single-bit and multi-bit PSFCH communication scheme according to some aspects of the present disclosure.

FIG. 6 is a block diagram of a user equipment (UE) according to some embodiments of the present disclosure.

FIG. 7 is a block diagram of an exemplary base station (BS) according to some embodiments of the present disclosure.

FIG. 8 illustrates a flow diagram of a wireless communication method according to some embodiments of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

This disclosure relates generally to wireless communications systems, also referred to as wireless communications networks. In various embodiments, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, Global System for Mobile Communications (GSM) networks, 5th Generation (5G) or new radio (NR) networks, as well as other communications networks. As described herein, the terms “networks” and “systems” may be used interchangeably.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the UMTS mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. In order to achieve these goals, further enhancements to LTE and LTE-A are considered in addition to development of the new radio technology for 5G NR networks. The 5G NR will be capable of scaling to provide coverage (1) to a massive Internet of things (IoTs) with a ultra-high density (e.g., ˜1M nodes/km²), ultra-low complexity (e.g., ˜10s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 ms), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

The 5G NR may be implemented to use optimized OFDM-based waveforms with scalable numerology and transmission time interval (TTI); having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 5, 10, 20 MHZ, and the like bandwidth (BW). For other various outdoor and small cell coverage deployments of TDD greater than 3 GHZ, subcarrier spacing may occur with 30 kHz over 80/100 MHz BW. For other various indoor wideband implementations, using a TDD over the unlicensed portion of the 5 GHz band, the subcarrier spacing may occur with 60 kHz over a 160 MHz BW. Finally, for various deployments transmitting with mmWave components at a TDD of 28 GHz, subcarrier spacing may occur with 120 kHz over a 500 MHz BW.

The scalable numerology of the 5G NR facilitates scalable TTI for diverse latency and quality of service (QOS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with UL/downlink scheduling information, data, and acknowledgement in the same subframe. The self-contained integrated subframe supports communications in unlicensed or contention-based shared spectrum, adaptive UL/downlink that may be flexibly configured on a per-cell basis to dynamically switch between UL and downlink to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may comprise at least one element of a claim.

NR technologies had been extended to operate over an unlicensed spectrum. The deployment of NR technologies over an unlicensed spectrum is referred to as NR-U. NR-U is targeted for operations over the 5 gigahertz (GHz) and 6 GHz bands, where there are well-defined channel access rules for sharing among operators of the same radio access technology (RAT) and/or of different RATs. When a BS operates over an unlicensed spectrum, the BS does not have ownership of the spectrum or control over the spectrum. Thus, the BS is required to contend for channel access in the spectrum, for example, via clear channel assessment (CCA) and/or listen-before-talk (LBT) procedures.

The provisioning of sidelink services, such as device-to-device (D2D), vehicle-to-vehicle (V2V), vehicle-to-everything (V2X), and/or cellular vehicle-to-everything (C-V2X) communications, over dedicated spectrum or licensed spectrum is relatively straight-forward as channel access in the dedicated spectrum or licensed spectrum is guaranteed. NR-U can bring benefit for sidelink services, for example, by offloading sidelink traffic to the unlicensed spectrum at no cost. However, channel access in a shared spectrum or an unlicensed spectrum is not guaranteed. Thus, to provision for sidelink services over a shared spectrum or unlicensed spectrum, sidelink user equipment devices (UEs) are required to contend for channel access in the spectrum, for example, via CCA and/or LBT procedures.

In sidelink (SL) communications, periodic physical sidelink feedback channel (PSFCH) resources are used to communicate acknowledgement/non-acknowledgement (ACK/NACK) of sidelink data. In some instances, a PSFCH may carry a single bit ACK/NACK in one resource block (RB). The periodic PSFCH resources may be referred to as PSFCH occasions. The PSFCH occasions may have a period of two slots, four slots, or any other suitable period. In some aspects, the relatively sparse periodicity of some PSFCH occasions may involve communicating multiple single-bit PSFCH communications simultaneously in a single PSFCH occasion. The single-bit PSFCH communications may be frequency domain multiplexed (FDM), with one PSFCH communication in each RB. For example, in some aspects, one or more sidelink UEs may transmit a plurality of PSSCH communications to a receiving sidelink UE. The multiple PSSCH communications may be unicast, groupcast, and/or multicast. For example, a first sidelink UE may transmit a plurality of PSSCH communications to a second sidelink UE within a PSFCH period. These communications may indicate, to the second sidelink UE, to schedule and transmit a plurality of PSFCH communications in a single PSFCH occasion. The UE may determine whether the number of scheduled PSFCH communications exceeds a configured UE capability. If the number of scheduled PSFCH communications does exceed the configured UE capability, the UE may select a subset or portion of the scheduled PSFCH communications for transmission. In some aspects, the UE may also determine whether the selected subset or portion of the scheduled PSFCH communications would exceed a maximum power threshold. If the maximum power threshold would be exceeded by transmitting all of the selected PSFCH communications, the UE may further down-select one or more PSFCH communications for transmission in the PSFCH occasion. The remaining PSFCH transmissions may be dropped.

In some aspects, a sidelink UE may transmit multi-bit PSFCH communications instead of or in addition to single-bit PSFCH communications. For example, Side link communications may be used for enhanced mobile broadband. In this regard, a first sidelink UE may transmit, to a second sidelink UE, a continuous stream of PSSCH communications. Accordingly, the number of bits associated with the PSFCH communication may be more than one to accommodate multiple PSSCH communications between PSFCH occasions. Further, sidelink UEs may employ carrier aggregation techniques to increase throughput. CA in sidelink may also benefit from multi-bit PSFCH communications. Further, if sidelink communications are employed in unlicensed bands, the period between PSFCH occasions may increase. Accordingly, it may be beneficial to use multi-bit PSFCH communication, in addition to single-bit PSFCH communications, in the expanded sidelink use cases.

Multi-bit sidelink communications may reduce the number of sidelink ACK/NACK indications that are multiplexed in the frequency domain. However, a sidelink UE may still not be capable of transmitting all of the scheduled multi-bit and/or single-bit PSFCH communications. As mentioned above, a sidelink UE may be configured with maximum number of single-bit PSFCH communications that can be FDM in a single PSFCH occasion. If multi-bit PSFCH communications are scheduled instead of or in addition to single-bit PSFCH communications, the configured maximum number of single-bit PSFCH communications, which may be referred to as a UE capability, may not be sufficient to regulate the multiplexing of PSFCH communications so that the UE capabilities are not exceeded and the transmit power of the PSFCH communications is maintained within a suitable range for detection by a receiving sidelink UE.

The present disclosure describes schemes, mechanisms, and devices for multiplexing single-bit and multi-bit PSFCH communications in one or more PSFCH occasions. In some aspects, the mechanisms described herein may include multiplexing and transmitting, by a first UE, one or more single-bit PSFCH communications and one or more multi-bit PSFCH communications based on a configured UE capability, where the configured UE capability allows the first UE to determine a first number of single-bit PSFCH communications for transmission, and a second number of multi-bit PSFCH communications for transmission. In some aspects, the configured UE capability may indicate a single maximum number of single-bit and/or multi-bit PSFCH communications. In another aspect, the configured UE capability may indicate a first maximum number of single-bit PSFCH communications, and a second maximum number of multi-bit PSFCH communications. In another aspect, the configured UE capability may indicate a first maximum number of single-bit PSFCH communications, a second maximum number of multi-bit PSFCH communications, and a total combined number of single-bit and multi-bit PSFCH communications. The UE may first down-select the first number of single-bit PSFCH communications and the second number of multi-bit PSFCH communications based on the configured UE capability. The UE may select the first number and second number based on one or more of the order of the scheduled PSFCH communications, the payload of the scheduled PSFCH communications, the cast type (e.g., unicast, groupcast, multicast) of the scheduled PSFCH communications, and/or the priority of the scheduled PSFCH communications. In some aspects, a combination of these parameters may be used to down-select a first set of single-bit PSFCH communications and a second set of multi-bit PSFCH communications.

In another aspect, the UE may select the first number of single-bit PSFCH communications and the second number of multi-bit PSFCH communications based on a PSFCH transmission power parameter or configuration. In some aspects, the PSFCH transmission power parameter may be indicated in the configured UE capability. In some aspects, the configured UE capability may further indicate whether a downlink (DL) pathloss-based power control parameter is enabled. The first number of single-bit PSFCH communications and the second number of multi-bit PSFCH communications may be based on whether the DL pathloss-based power control parameter is enabled. In some aspects, the DL pathloss-based power control parameter may include an indication of a dl-P0-PSFCH field or value. The PSFCH transmission power parameter may indicate one or more maximum transmission power values. The UE may select or determine, based on the one or more maximum transmission power values, the first number of single-bit PSFCH communications and the second number of multi-bit PSFCH communications. For example, the UE may select, based on the one or more maximum transmission power values, the first number of single-bit PSFCH communications such that the first number of single-bit PSFCH communications does not exceed a first maximum transmission power value. The UE may further select, based on the one or more maximum transmission power values, the second number of multi-bit PSFCH communications such that the second number of multi-bit PSFCH communications does not exceed a second maximum transmission power value. In a further aspect, if the DL pathloss-based power control parameter is not enabled, the UE may autonomously determine the first number of single-bit PSFCH communications and the second number of multi-bit PSFCH communications. The UE may further determine a transmission power for each of the first number of single-bit PSFCH communications and the second number of multi-bit PSFCH communications.

The aspects mentioned above allow for a sidelink UE to multiplex and communicate one or more single-bit PSFCH communications and one or more multi-bit PSFCH communications while satisfying maximum PSFCH multiplexing capabilities, and PSFCH transmission power capabilities. Accordingly, a combination of single-bit and multi-bit PSFCH communications indicating ACK/NACK for one or more sidelink data communications, can be scheduled, multiplexed, and communicated reliably. Thus, the ability of the sidelink UE to indicate successful/unsuccessful sidelink communications is enhanced, in that a greater number of ACK/NACK may be transmitted in a single PSFCH communication. In this regard, the throughput, reliability, and user experience of the sidelink communications is enhanced.

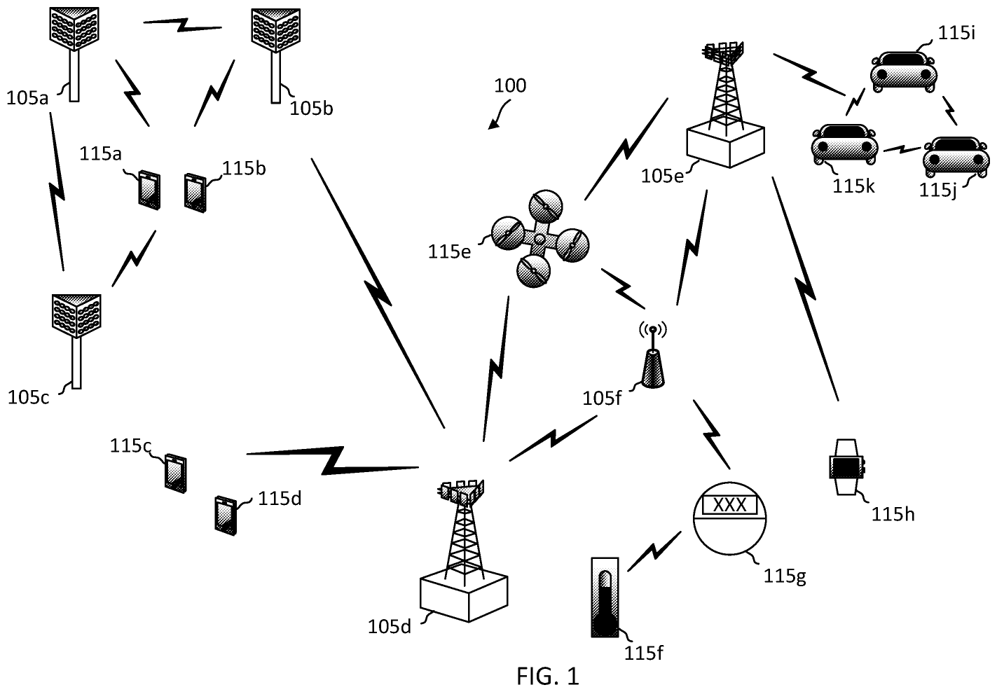

FIG. 1 illustrates a wireless communication network 100 according to some aspects of the present disclosure. The network 100 may be a 5G network. The network 100 includes a number of base stations (BSs) 105 (individually labeled as 105a, 105b, 105c, 105d, 105e, and 105f) and other network entities. A BS 105 may be a station that communicates with UEs 115 and may also be referred to as an evolved node B (eNB), a next generation eNB (gNB), an access point, and the like. Each BS 105 may provide communication coverage for a particular geographic area. In 3GPP, the term “cell” can refer to this particular geographic coverage area of a BS 105 and/or a BS subsystem serving the coverage area, depending on the context in which the term is used.

A BS 105 may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In the example shown in FIG. 1, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. A BS 105 may support one or multiple (e.g., two, three, four, and the like) cells.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices. The UEs 115a-115d are examples of mobile smart phone-type devices accessing network 100. A UE 115 may also be a machine specifically configured for connected communication, including machine type communication (MTC), enhanced MTC (eMTC), narrowband IoT (NB-IoT) and the like. The UEs 115e-115h are examples of various machines configured for communication that access the network 100. The UEs 115i-115k are examples of vehicles equipped with wireless communication devices configured for communication that access the network 100. A UE 115 may be able to communicate with any type of the BSs, whether macro BS, small cell, or the like. In FIG. 1, a lightning bolt (e.g., communication links) indicates wireless transmissions between a UE 115 and a serving BS 105, which is a BS designated to serve the UE 115 on the downlink (DL) and/or uplink (UL), desired transmission between BSs 105, backhaul transmissions between BSs, or sidelink transmissions between UEs 115.

In operation, the BSs 105a-105c may serve the UEs 115a and 115b using 3D beamforming and coordinated spatial techniques, such as coordinated multipoint (COMP) or multi-connectivity. The macro BS 105d may perform backhaul communications with the BSs 105a-105c, as well as small cell, the BS 105f. The macro BS 105d may also transmits multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an example of a gNB or an access node controller (ANC)) may interface with the core network through backhaul links (e.g., NG-C, NG-U, etc.) and may perform radio configuration and scheduling for communication with the UEs 115. In various examples, the BSs 105 may communicate, either directly or indirectly (e.g., through core network), with each other over backhaul links (e.g., X1, X2, etc.), which may be wired or wireless communication links.

The network 100 may also support mission critical communications with ultra-reliable and redundant links for mission critical devices, such as the UE 115e, which may be a drone. Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), and UE 115h (e.g., wearable device) may communicate through the network 100 either directly with BSs, such as the small cell BS 105f, and the macro BS 105e, or in multi-step-size configurations by communicating with another user device which relays its information to the network, such as the UE 115f communicating temperature measurement information to the smart meter, the UE 115g, which is then reported to the network through the small cell BS 105f. The network 100 may also provide additional network efficiency through dynamic, low-latency TDD/FDD communications, such asV2V, V2X, C-V2X communications between a UE 115i, 115j, or 115k and other UEs 115, and/or vehicle-to-infrastructure (V21) communications between a UE 115i, 115j, or 115k and a BS 105.

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some instances, the subcarrier spacing between adjacent subcarriers may be fixed, and the total number of subcarriers (K) may be dependent on the system BW. The system BW may also be partitioned into subbands. In other instances, the subcarrier spacing and/or the duration of TTIs may be scalable.

In some aspects, the BSs 105 can assign or schedule transmission resources (e.g., in the form of time-frequency resource blocks (RB)) for downlink (DL) and uplink (UL) transmissions in the network 100. DL refers to the transmission direction from a BS 105 to a UE 115, whereas UL refers to the transmission direction from a UE 115 to a BS 105. The communication can be in the form of radio frames. A radio frame may be divided into a plurality of subframes or slots, for example, about 10. Each slot may be further divided into mini-slots. In a FDD mode, simultaneous UL and DL transmissions may occur in different frequency bands. For example, each subframe includes a UL subframe in a UL frequency band and a DL subframe in a DL frequency band. In a TDD mode, UL and DL transmissions occur at different time periods using the same frequency band. For example, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For example, each DL or UL subframe may have pre-defined regions for transmissions of reference signals, control information, and data. Reference signals are predetermined signals that facilitate the communications between the BSs 105 and the UEs 115. For example, a reference signal can have a particular pilot pattern or structure, where pilot tones may span across an operational BW or frequency band, each positioned at a pre-defined time and a pre-defined frequency. For example, a BS 105 may transmit cell specific reference signals (CRSs) and/or channel state information-reference signals (CSI-RSs) to enable a UE 115 to estimate a DL channel. Similarly, a UE 115 may transmit sounding reference signals (SRSs) to enable a BS 105 to estimate a UL channel. Control information may include resource assignments and protocol controls. Data may include protocol data and/or operational data. In some aspects, the BSs 105 and the UEs 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. A UL-centric subframe may include a longer duration for UL communication than for UL communication.

In some aspects, the network 100 may be an NR network deployed over a licensed spectrum. The BSs 105 can transmit synchronization signals (e.g., including a primary synchronization signal (PSS) and a secondary synchronization signal (SSS)) in the network 100 to facilitate synchronization. The BSs 105 can broadcast system information associated with the network 100 (e.g., including a master information block (MIB), remaining system information (RMSI), and other system information (OSI)) to facilitate initial network access. In some instances, the BSs 105 may broadcast the PSS, the SSS, and/or the MIB in the form of synchronization signal block (SSBs) over a physical broadcast channel (PBCH) and may broadcast the RMSI and/or the OSI over a physical downlink shared channel (PDSCH).

In some aspects, a UE 115 attempting to access the network 100 may perform an initial cell search by detecting a PSS from a BS 105. The PSS may enable synchronization of period timing and may indicate a physical layer identity value. The UE 115 may then receive a SSS. The SSS may enable radio frame synchronization, and may provide a cell identity value, which may be combined with the physical layer identity value to identify the cell. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI and/or OSI. After decoding the MIB, the UE 115 may receive RMSI and/or OSI. The RMSI and/or OSI may include radio resource control (RRC) information related to random access channel (RACH) procedures, paging, control resource set (CORESET) for physical downlink control channel (PDCCH) monitoring, physical UL control channel (PUCCH), physical UL shared channel (PUSCH), power control, and SRS

After obtaining the MIB, the RMSI and/or the OSI, the UE 115 can perform a random access procedure to establish a connection with the BS 105. In some examples, the random access procedure may be a four-step random access procedure. For example, the UE 115 may transmit a random access preamble and the BS 105 may respond with a random access response. The random access response (RAR) may include a detected random access preamble identifier (ID) corresponding to the random access preamble, timing advance (TA) information, a UL grant, a temporary cell-radio network temporary identifier (C-RNTI), and/or a backoff indicator. Upon receiving the random access response, the UE 115 may transmit a connection request to the BS 105 and the BS 105 may respond with a connection response. The connection response may indicate a contention resolution. In some examples, the random access preamble, the RAR, the connection request, and the connection response can be referred to as message 1 (MSG1), message 2 (MSG2), message 3 (MSG3), and message 4 (MSG4), respectively. In some examples, the random access procedure may be a two-step random access procedure, where the UE 115 may transmit a random access preamble and a connection request in a single transmission and the BS 105 may respond by transmitting a random access response and a connection response in a single transmission.

After establishing a connection, the UE 115 and the BS 105 can enter a normal operation stage, where operational data may be exchanged. For example, the BS 105 may schedule the UE 115 for UL and/or DL communications. The BS 105 may transmit UL and/or DL scheduling grants to the UE 115 via a PDCCH. The scheduling grants may be transmitted in the form of DL control information (DCI). The BS 105 may transmit a DL communication signal (e.g., carrying data) to the UE 115 via a PDSCH according to a DL scheduling grant. The UE 115 may transmit a UL communication signal to the BS 105 via a PUSCH and/or PUCCH according to a UL scheduling grant.

In some aspects, the BS 105 may communicate with a UE 115 using HARQ techniques to improve communication reliability, for example, to provide a URLLC service. The BS 105 may schedule a UE 115 for a PDSCH communication by transmitting a DL grant in a PDCCH. The BS 105 may transmit a DL data packet to the UE 115 according to the schedule in the PDSCH. The DL data packet may be transmitted in the form of a transport block (TB). If the UE 115 receives the DL data packet successfully, the UE 115 may transmit a HARQ ACK to the BS 105. Conversely, if the UE 115 fails to receive the DL transmission successfully, the UE 115 may transmit a HARQ NACK to the BS 105. Upon receiving a HARQ NACK from the UE 115, the BS 105 may retransmit the DL data packet to the UE 115. The retransmission may include the same coded version of DL data as the initial transmission. Alternatively, the retransmission may include a different coded version of the DL data than the initial transmission. The UE 115 may apply soft-combining to combine the encoded data received from the initial transmission and the retransmission for decoding. The BS 105 and the UE 115 may also apply HARQ for UL communications using substantially similar mechanisms as the DL HARQ.

In some aspects, the network 100 may operate over a system BW or a component carrier (CC) BW. The network 100 may partition the system BW into multiple BWPs (e.g., portions). A BS 105 may dynamically assign a UE 115 to operate over a certain BWP (e.g., a certain portion of the system BW). The assigned BWP may be referred to as the active BWP. The UE 115 may monitor the active BWP for signaling information from the BS 105. The BS 105 may schedule the UE 115 for UL or DL communications in the active BWP. In some aspects, a BS 105 may assign a pair of BWPs within the CC to a UE 115 for UL and DL communications. For example, the BWP pair may include one BWP for UL communications and one BWP for DL communications.

In some aspects, the network 100 may operate over a shared channel, which may include shared frequency bands or unlicensed frequency bands. For example, the network 100 may be an NR-unlicensed (NR-U) network operating over an unlicensed frequency band. In such an aspect, the BSs 105 and the UEs 115 may be operated by multiple network operating entities. To avoid collisions, the BSs 105 and the UEs 115 may employ a listen-before-talk (LBT) procedure to monitor for transmission opportunities (TXOPs) in the shared channel. For example, a transmitting node (e.g., a BS 105 or a UE 115) may perform an LBT prior to transmitting in the channel. When the LBT passes, the transmitting node may proceed with the transmission. When the LBT fails, the transmitting node may refrain from transmitting in the channel. In an example, the LBT may be based on energy detection. For example, the LBT results in a pass when signal energy measured from the channel is below a threshold. Conversely, the LBT results in a failure when signal energy measured from the channel exceeds the threshold. In another example, the LBT may be based on signal detection. For example, the LBT results in a pass when a channel reservation signal (e.g., a predetermined preamble signal) is not detected in the channel. A TXOP may also be referred to as channel occupancy time (COT).

In some aspects, the network 100 may provision for sidelink communications to allow a UE 115 to communicate with another UE 115 without tunneling through a BS 105 and/or the core network. The BS 105 may configure certain resources in a licensed band and/or an unlicensed band for sidelink communications between the UE 115 and the other UE 115. A UE 115 may transmit, during sidelink communications, physical sidelink shared channel (PSSCH) data, physical sidelink shared control channel (PSCCH) sidelink control information (SCI), sidelink COT sharing SCI, sidelink scheduling SCI, and/or physical sidelink feedback channel (PSFCH) ACK/NACK feedbacks (e.g., HARQ for sidelink) to another UE and/or receive PSSCH data, PSCCH SCI, sidelink COT sharing SCI, sidelink scheduling SCI, and/or PSFCH ACK/NACK feedbacks from another UE 115.

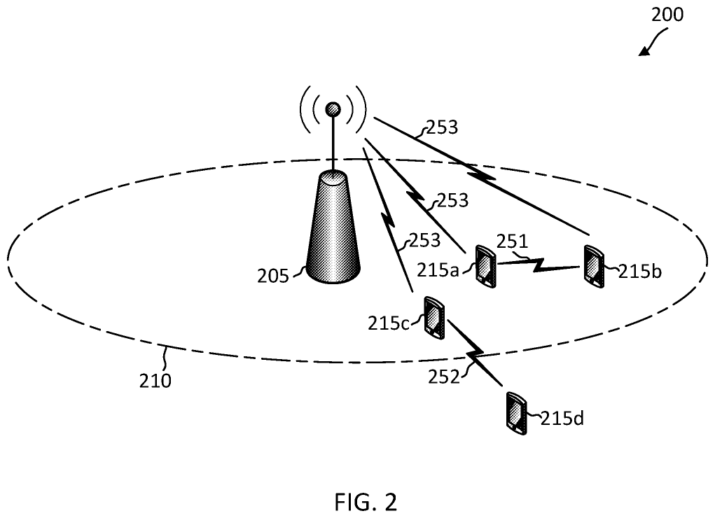

FIG. 2 illustrates an example of a wireless communication network 200 that provisions for sidelink communications according to embodiments of the present disclosure. The network 200 may be similar to the network 100. FIG. 2 illustrates one BS 205 and four UEs 215 for purposes of simplicity of discussion, though it will be recognized that embodiments of the present disclosure may scale to any suitable number of UEs 215 and/or BSs 205 (e.g., 2, 3, 6, 7, 8, or more). The BS 205 and the UEs 215 may be similar to the BSs 105 and the UEs 115, respectively. The BS 205 and the UEs 215 may communicate over the same spectrum.

In the network 200, some of the UEs 215 may communicate with each other in peer-to-peer communications. For example, the UE 215a may communicate with the UE 215b over a sidelink 251, and the UE 215c may communicate with the UE 215d over another sidelink 252. In some instances, the sidelinks 251 and 252 are unicast bidirectional links, each between a pair of UEs 215. In some other instances, the sidelinks 251 and 252 can be multicast links supporting multicast sidelink services among the UEs 215. Multicast sidelink services may include groupcast or broadcast links. In a groupcast link, a transmitting UE 215 has a link with a sub-set of specific UEs 215 in its vicinity. In a broadcast link, a transmitting UE 215 has a link with all UEs 215 within its range. As an example of multicast sidelink services, the UE 215c may transmit multicast data to the UE 215d and the UE 215b over sidelinks.

Some of the UEs 215 may also communicate with the BS 205 in a UL direction and/or a DL direction via communication links 253. For instance, the UE 215a, 215b, and 215c are within a coverage area 210 of the BS 205, and thus may be in communication with the BS 205. The UE 215d is outside the coverage area 210, and thus may not be in direct communication with the BS 205. In some instances, the UE 215c may operate as a relay for the UE 215d to reach the BS 205. In some aspects, some of the UEs 215 are associated with vehicles (e.g., similar to the UEs 115i-k) and the communications over the sidelinks 251 and/or 252 may be C-V2X communications. C-V2X communications may refer to communications between vehicles and any other wireless communication devices in a cellular network.

In some aspects, the network 200 may be a LTE network. The transmissions by the UE 215a and the UE 215b over the sidelink 251 and/or the transmissions by the UE 215c and the UE 215d over the sidelink 252 may reuse a LTE PUSCH waveform, which is a discrete Fourier transform-spreading (DFT-s) based waveform. In some aspects, the network 200 may be an NR network. The transmissions by the UEs 215 over the sidelinks 251 and/or 252 may use a cyclic-prefix-OFDM (CP-OFDM) waveform. In some aspects, the network 200 may operate over a shared radio frequency band (e.g., an unlicensed band). The transmissions by the UEs 215 over the sidelinks 251 and/or 252 may use a frequency interlaced waveform.

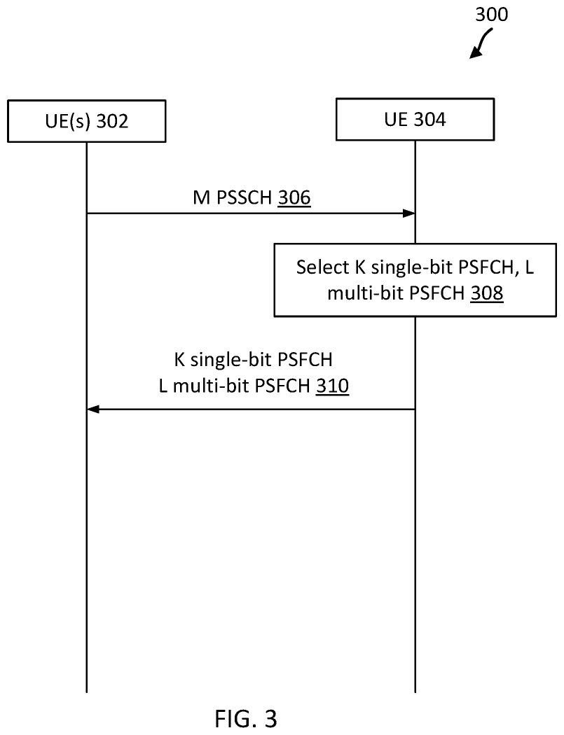

FIGS. 3-5 illustrate methods, schemes, and mechanisms for multiplexing and communicating single-bit and/or multi-bit PSFCH communications in a PSFCH occasion. In some aspects, each of the methods, schemes, and mechanisms illustrated in FIGS. 3-5 may involve determining or selecting, based on a PSFCH capability configuration, a first number of single-bit PSFCH communications and a second number of multi-bit PSFCH communications. The PSFCH capability configuration may be preconfigured in a UE and stored in a memory of the UE, or may be signaled or otherwise communicated based on RRC signaling, MAC information elements, MAC control elements, sidelink control information (SCI), and/or any other suitable mechanism type of control signaling, message, and/or data communication. In another aspect, the PSFCH capability configuration may indicate one or more transmission power parameters or limits, such as a maximum total PSFCH transmission power.

Referring to FIG. 3, a signaling diagram is illustrated for a method 300 of wireless communication, according to aspects of the present disclosure. The method 300 is performed by a first sidelink UE 304, and one or more second sidelink UEs 302. In action 306, the one or more second sidelink UEs 302 transmit, and the first sidelink UE 304 receives, M physical sidelink shared channel (PSSCH) communications. In some aspects, the M PSSCH communications may include sidelink data. The one or more second sidelink UEs 302 may transmit the M PSSCH communications between a first physical sidelink feedback channel (PSFCH) occasion, and a second PSFCH occasion. For example, the M PSSCH communications may be communicated in a continuous or semi-continuous stream. In some aspects, the M PSSCH communications communicated in action 306 may be scheduled for, or otherwise associated with, a single PSFCH occasion. For example, the M PSSCH communications may indicate that M PSFCH communications are scheduled for the single PSFCH occasion, where the M PSFCH communications may include one or more single-bit PSFCH communications, and one or more multi-bit PSFCH communications.

At action 308, the first sidelink UE 304 selects K single-bit and L multi-bit PSFCH communications. In some aspects, K and L may be integers. In some aspects, the number K may be 0, 1, 2, 3, 5, 7, and/or any other integer. Similarly, the number L may be 0, 1, 2, 3, 5, 7, and/or any other integer. Action 308 may include determining or selecting the K single-bit PSFCH communications and L multi-bit PSFCH communications based on a PSFCH capability configuration. For example, the first sidelink UE 304 may be configured with a PSFCH capability configuration indicating, for example, one or more maximum numbers of single-bit and/or multi-bit PSFCH communications for multiplexing. In some aspects, the PSFCH capability configuration may also indicate one or more parameters or rules for selecting up to the one or more maximum numbers of single-bit and/or multi-bit PSFCH communications. For example, the PSFCH capability configuration may indicate a total maximum number of PSFCH communications, whether single-bit or multi-bit. The PSFCH capability configuration may further indicate that the first sidelink UE 304 selects or determines which of the scheduled M PSFCH communications may be multiplexed based on one or more orders, rankings, or other parameters, including PSFCH priority, PSFCH order, PSFCH payload, PSSCH cast type (e.g., unicast, multicast, groupcast, etc.), and/or any combination thereof.

In another aspect, the PSFCH capability configuration may indicate one or more transmission power limits, thresholds, or other parameters for selecting the K single-bit and L multi-bit PSFCH communications for transmission. For example, action 308 may include selecting Q single-bit and W multi-bit PSFCH communications for multiplexing based on one or more configured maximum numbers of PSFCH communications, and then selecting the K single-bit PSFCH communications and L multi-bit PSFCH communications based on the PSFCH power configuration. The configured maximum numbers and the transmission power parameters may be included or indicated in the PSFCH capability configuration.

At action 310, the first sidelink UE 304 transmits, and the one or more second sidelink UEs 302 receive, in a single PSFCH occasion, the K single-bit PSFCH communications and the L multi-bit PSFCH communications. In some aspects, the PSFCH communications transmitted at action 310 may be multiplexed in the frequency domain. For example, the first sidelink UE 304 may be transmitted in one or more contiguous symbols allocated for PSFCH communication. The one or more PSFCH communications may indicate ACK/NACK associated with one or more PSSCH communications. Each PSFCH communication may be FDM such that one PSFCH communication is allocated in one or more resource blocks (RBs). In some aspects, each PSFCH communication may have a same format as a physical uplink control channel (PUCCH) communication with format 0. The first UE 304 may be configured with PSFCH occasions allocated every two slots, every three slots, every four slots, every five slots, every eight slots, or any other suitable periodicity.

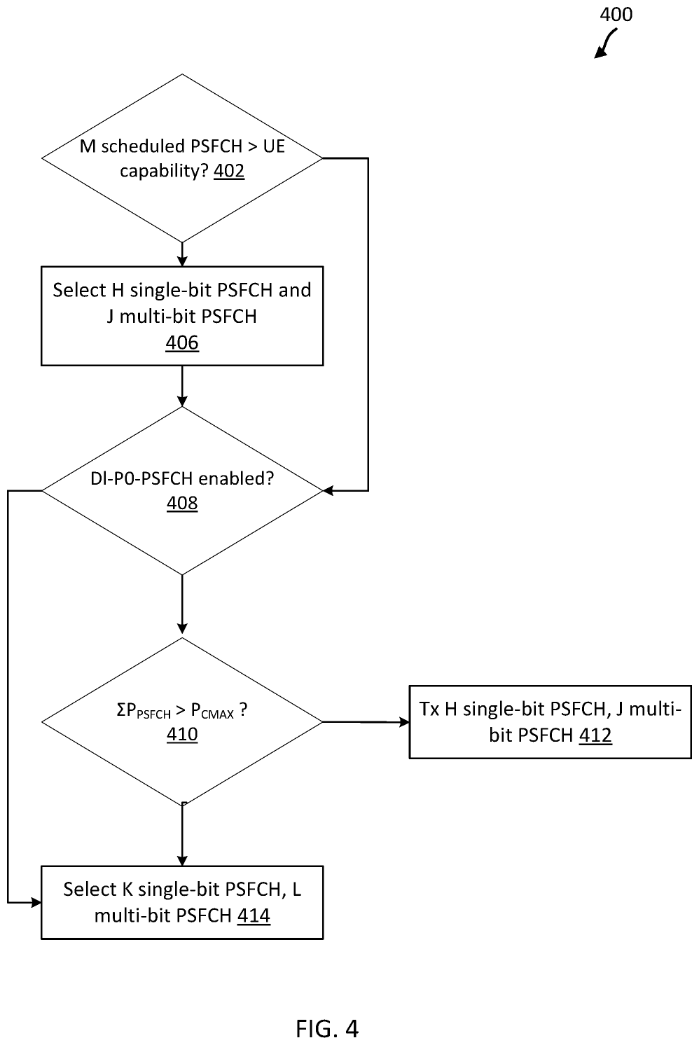

FIG. 4 is a flow diagram illustrating a method 400 for multiplexing and communicating one or more single-bit PSFCH communications, and one or more multi-bit PSFCH communications. The method 400 may be performed by a UE, such as one of the UEs 115 of the network 100, or the first sidelink UE 304. The method 400 may include one or more steps or aspects of the method 300 described above. In some aspects, the method 400 may be performed in response to receiving M PSSCH communications associated with a single PSFCH occasion.

At action 402, the sidelink UE determines whether the M scheduled PSFCH communications associated with the M PSSCH communications exceed a configured UE capability. For example, as explained above, the UE may be configured with a PSFCH capability configuration indicating at least one maximum number of PSFCH communications for a PSFCH occasion. For example, the PSFCH capability configuration may indicate a single total maximum number of PSFCH communications, including single-bit and multi-bit PSFCH communications, that can be multiplexed and/or transmitted in a single PSFCH occasion. In another aspect, the PSFCH capability configuration may indicate a first maximum number of single-bit PSFCH communications, and a second maximum number of multi-bit PSFCH communications that can be multiplexed and/or transmitted in the single PSFCH communication. In another aspect, the PSFCH capability configuration may indicate a first maximum number of single-bit PSFCH communications, a second maximum number of multi-bit PSFCH communications, and a combined maximum number of PSFCH communications that can be multiplexed and/or transmitted in the single PSFCH communication. Accordingly, action 402 may include comparing the total number of single-bit and multi-bit PSFCH communications scheduled for the PSFCH occasion to the total maximum number of PSFCH communications. In another aspect, action 402 may include comparing the scheduled single-bit PSFCH communications to the first maximum number of single-bit PSFCH communications, and the scheduled multi-bit PSFCH communications to the second maximum number of multi-bit PSFCH communications. Further, in some aspects, the UE may compare the total number of scheduled PSFCH communications to the combined maximum number of PSFCH communications.

If the M scheduled PSFCH communications do not exceed the one or more maximum configured numbers described above, the UE may determine whether a downlink (DL) pathloss-based PSFCH parameter (dl-P0-PSFCH) is enabled in action 408. In action 406, if the M scheduled PSFCH communications do exceed the one or more maximum configured numbers described above, the UE may select H single-bit PSFCH communications and J multi-bit PSFCH communications for multiplexing, based on the PSFCH capability configuration.

In one aspect, the PSFCH capability configuration may include or indicate a single maximum number of PSFCH communications, including single-bit and multi-bit PSFCH communications, that can be simultaneously transmitted by the UE in a single PSFCH occasion. In some aspects, the single maximum number of PSFCH communications may be referred to as N_{max,epsfch}. If the UE has N1 single-bit PSFCH communications and N2 multi-bit PSFCH communications scheduled for the PSFCH occasion, where M=N1+N2, and M>N_{max,epsfch}, then the UE may first select a group or subset of the M PSFCH communications, including H single-bit PSFCH communications and J multi-bit PSFCH communications, such that H+J=N_{max,epsfch}. The UE may select the H single-bit PSFCH communications and the J multi-bit PSFCH communications based on one or more configured rules or parameters, where the configured rules or parameters are based on PSFCH priority, PSFCH payload size, PSFCH cast type, and/or combinations thereof. In one aspect, the UE selects N_{max,epsfch} PSFCH communications from the scheduled M PSFCH communications based on an ascending order of priority of each of the scheduled PSFCH communications. In another aspect, the UE selects N_{max,epsfch} PSFCH communications from the scheduled M PSFCH communications based on a descending order of the PSFCH payload of each of the scheduled PSFCH communications. In another aspect, the UE selects N_{max,epsfch} PSFCH communications from the scheduled M PSFCH communications based on a cast type of the scheduled PSFCH communications. For example, the UE may select the groupcast/multicast PSFCH communications first, and unicast PSFCH communications second. In another aspect, the UE selects N_{max,epsfch} PSFCH communications from the scheduled M PSFCH communications based on an ascending order of the priority of the scheduled PSFCH communications first, and then based on a descending order of PSFCH payload size for PSFCH communications with a same PSFCH priority. In another aspect, the UE selects N_{max,epsfch} PSFCH communications from the scheduled M PSFCH communications based on a descending order of the PSFCH payload size of the scheduled PSFCH communications first, and then based on an ascending order of priority for PSFCH communications with a same PSFCH payload size. In another aspect, the UE selects N_{max,epsfch} PSFCH communications from the scheduled M PSFCH communications based on an ascending order of the priority of the scheduled PSFCH communications first, and then based on a descending order of PSFCH payload size for PSFCH communications with a same PSFCH priority, and then based on cast type (e.g., multicast/groupcast first, unicast second; or unicast first, multicast/groupcast second) for PSFCH communications with the same priority and the same payload size. It will be understood that the rules, parameters, and combinations explicitly described above for selecting the N_{max,epsfch} PSFCH communications are exemplary and are not intended to be limiting. Accordingly, the various rules, parameters, and combinations thereof may be combined, substituted, and/or otherwise modified without departing from the scope of the present disclosure.

In another example, the PSFCH capability configuration may include or indicate a first maximum number of single-bit PSFCH communications, and a second maximum number of multi-bit PSFCH communications, that can be simultaneously transmitted by the UE in a single PSFCH occasion. In some aspects, the first maximum number of single-bit PSFCH communications may be referred to as N_{max,spsfch}, and the second maximum number of multi-bit PSFCH communications may be referred to as N_{max,mpsfch}. If the UE has N1 single-bit PSFCH communications scheduled for the PSFCH occasion, and N1>N_{max,spsfch}, then the UE may first select N_{max,spsfch} PSFCH communications. The UE may select the N_{max,spsfch} PSFCH communications based on one or more configured rules or parameters, where the configured rules or parameters are based on PSFCH priority, PSFCH cast type, and/or combinations thereof. In one aspect, the UE selects N_{max,spsfch} PSFCH communications from the scheduled N1 single-bit PSFCH communications based on an ascending order of priority of each of the scheduled PSFCH communications. In another aspect, the UE selects N_{max,spsfch} PSFCH communications from the scheduled N1 single-bit PSFCH communications based on a cast type of the scheduled PSFCH communications. For example, the UE may select the groupcast/multicast PSFCH communications first, and unicast PSFCH communications second. In another aspect, the UE selects N_{max,spsfch} PSFCH communications from the scheduled N1 single-bit PSFCH communications based on an ascending order of the priority of the scheduled PSFCH communications first, and then based on a cast type (e.g., e.g., multicast/groupcast first, unicast second; or unicast first, multicast/groupcast second) for PSFCH communications with a same PSFCH priority. In another aspect, the UE selects N_{max,spsfch} PSFCH communications from the scheduled N1 single-bit PSFCH communications based on based on cast type (e.g., multicast/groupcast first, unicast second; or unicast first, multicast/groupcast second) for PSFCH communications, and then based on an ascending order of priority for PSFCH communications with the same cast type. It will be understood that the rules, parameters, and combinations explicitly described above for selecting the N_{max,spsfch} PSFCH communications are exemplary and are not intended to be limiting. Accordingly, the various rules, parameters, and combinations thereof may be combined, substituted, and/or otherwise modified without departing from the scope of the present disclosure.

In another aspect, if the UE has N2 multi-bit PSFCH communications scheduled for the PSFCH occasion, and N2>N_{max,mpsfch}, then the UE may first select N_{max,mpsfch} PSFCH communications. The UE may select the N_{max,mpsfch} PSFCH communications based on one or more configured rules or parameters, where the configured rules or parameters are based on PSFCH priority, PSFCH payload size, PSFCH cast type, and/or combinations thereof. In one aspect, the UE selects N_{max,mpsfch} PSFCH communications from the scheduled N2 multi-bit PSFCH communications based on an ascending order of priority of each of the scheduled PSFCH communications. In another aspect, the UE selects N_{max,mpsfch} PSFCH communications from the scheduled N2 multi-bit PSFCH communications based on a descending order of the PSFCH payload of each of the scheduled PSFCH communications. In another aspect, the UE selects N_{max,mpsfch} PSFCH communications from the scheduled N2 multi-bit PSFCH communications based on a cast type of the scheduled PSFCH communications. For example, the UE may select the groupcast/multicast PSFCH communications first, and unicast PSFCH communications second. In another aspect, the UE selects N_{max,mpsfch} PSFCH communications from the scheduled N2 multi-bit PSFCH communications based on an ascending order of the priority of the scheduled PSFCH communications first, and then based on a descending order of PSFCH payload size for PSFCH communications with a same PSFCH priority. In another aspect, the UE selects N_{max,mpsfch} PSFCH communications from the scheduled N2 multi-bit PSFCH communications based on a descending order of the PSFCH payload size of the scheduled PSFCH communications first, and then based on an ascending order of priority for PSFCH communications with a same PSFCH payload size. In another aspect, the UE selects N_{max,mpsfch} PSFCH communications from the scheduled N2 multi-bit PSFCH communications based on an ascending order of the priority of the scheduled PSFCH communications first, and then based on a descending order of PSFCH payload size for PSFCH communications with a same PSFCH priority, and then based on cast type (e.g., multicast/groupcast first, unicast second; or unicast first, multicast/groupcast second) for PSFCH communications with the same priority and the same payload size. It will be understood that the rules, parameters, and combinations explicitly described above for selecting the N_{max,mpsfch} PSFCH communications are exemplary and are not intended to be limiting. Accordingly, the various rules, parameters, and combinations thereof may be combined, substituted, and/or otherwise modified without departing from the scope of the present disclosure.

In another aspect, the PSFCH capability configuration may include or indicate a first maximum number of single-bit PSFCH communications, a second maximum number of multi-bit PSFCH communications, and a combined or total number of PSFCH communications, that can be simultaneously transmitted by the UE in a single PSFCH occasion. The combined total number of PSFCH communications, used in conjunction with the first maximum number of single-bit PSFCH communications and the second maximum number of multi-bit PSFCH communications, may be referred to as N_{max,tpsfch}. The UE may select N1 single-bit and/or N2 multi-bit PSFCH communications as described above based on one or more of PSFCH payload size, PSFCH priority, PSFCH cast type, and/or any other suitable PSFCH parameter or combination thereof. Further, if the total number M of scheduled PSFCH communications is greater than N_{max,tpsfch}, the UE may select N_{max,tpsfch} PSFCH communications based on the rules, parameters described above.

At action 408, the UE determines whether dl-P0-PSFCH is enabled. As mentioned above, dl-P0-PSFCH may be a DL pathloss-based power control parameter. In some aspects, dl-P0-PSFCH may be a field indicated in an SL-ResourcePool information element (IE). In some aspects, dl-P0-PSFCH may be indicated in an SL-PowerControl field of the SL-ResourcePool information element. The dl-P0-PSFCH field may indicate a P0 value for the DL pathloss-based power control for PSFCH. If dl-P0-PSFCH is not configured, DL pathloss-based power control may be disabled for PSFCH communications. If dl-P0-PSFCH is configured, the SL-PowerControl field may also include or indicate a dl-Alpha-PSFCH value, which indicates an alpha value for DL pathloss-based power control.

If dl-P0-PSFCH is not configured/enabled, the UE may autonomously select K single-bit PSFCH communications and L multi-bit PSFCH communications in action 414. If dl-P0-PSFCH is configured/enabled, in action 410, the UE determines if the sum of the transmission power for all of the selected PSFCH communications from action 406 or 402 exceeds a configured maximum power P_{CMAX}. In some aspects, the transmission power for a selected PSFCH communication n in a PSFCH occasion j may be determined based on the following formula:

$${P}_{PSFCH , n} ( j ) = {P}_{O , PSFCH} + 10 {log}_{10} ( {2}^{μ} * {M}_{PSFCH , n} ) + {α}_{PSFCH} * P L \qquad ( 1 )$$

Where M_{PSFCH,n} is the number of RBs occupied by PSFCH n, P_{O,PSFCH} is provided by dl-P0-PSFCH, and α_{PSFCH} is provided by dl-Alpha-PSFCH. If the sum of the transmission power for the selected (N1+N2) PSFCH communications is less than or equal to P_{CMAX}, then the UE transmits, in step 412, the number of PSFCH communications is equal to the PSFCH communications selected in step 402 (if the total scheduled PSFCH for PSFCH occasion j is less than or equal to UE PSFCH multiplexing capabilities), or the PSFCH communications (H+J) selected in action 406.

If the sum of the transmission power for the selected (N1+N2) PSFCH communications is larger than P_{CMAX}, then the UE may autonomously determine, in action 414, the number of PSFCH communications for transmission based one PSFCH priority, payload size, cast type, or a combination of these parameters. The UE may autonomously select the number of PSFCH communications for transmission subject to a lower bound, which may be the higher of 1, and another value based on priority, cast type, payload size, or some other value. For example, in action 414, the UE may determine or select K single-bit and L multi-bit PSFCH communications such that:

$$( K + L ) \geq max ( 1 , {M}_{1} + {M}_{2} + … + {M}_{Z} ) \qquad ( 2 )$$

where Mᵢ is a number of PSFCH communications with priority value i, and Z is the largest value of i which does not cause the total transmission power of the PSFCH communications to exceed P_{CMAX}. In other words, Z is the largest value which satisfies the following relationship:

$${\sum }_{i = 1}^{Z} {\sum }_{m = 1}^{{M}_{i}} {P}_{PSFCH , i , m} \leq {P}_{CMAX} \qquad ( 3 )$$

In some aspects, Z and i may correspond to a priority value. For example, in some aspects, P_{PSFCH,i,m} is the PSFCH transmission power for the m^{th} PSFCH with priority value i. In other aspects, Z and i may correspond to a payload size. For example, in some aspects, P_{PSFCi,m} is the PSFCH transmission power for the m^{th} PSFCH with the i^{th} largest payload size value Iᵢ. In another aspect, Z and i may correspond to a cast type. For example, in some aspects, if the sum of the transmission power of the selected K+L PSFCH communications exceeds P_{CMAX}, the UE may select the groupcast PSFCH communications first, and the unicast PSFCH communications second. In another example, the UE may select the unicast PSFCH communications first, and the groupcast PSFCH communications second. Within the cast type, the UE may select the K single-bit and L multi-bit PSFCH communications based on priority. For example, if groupcast is selected by the UE first, and the sum of the transmission power for the groupcast PSFCH communications is less than or equal to P_{CMAX}, then the total K+L=N_{Tx,epsfch} PSFCH communications may be autonomously determined by the UE such that N_{Tx,epsfch}≥G+max (1, M₁+M₂+ . . . +M_{Z}), where G is the total number of groupcast PSFCH communications, Mᵢ is the number of PSFCH communications corresponding to unicast with priority value i, and Z is the largest value which does not cause the total transmission power of the PSFCH communications to exceed P_{CMAX}. In other words, Z may be defined as the largest value which satisfies the following relationship:

$${\sum }_{g = 1}^{G} {P}_{PSFCH , g} + {\sum }_{i = 1}^{Z} {\sum }_{m = 1}^{{M}_{i}} {P}_{PSFCH , i , m} \leq {P}_{CMAX} \qquad ( 4 )$$

where P_{PSFCH,g} is the PSFCH transmission power for the g^{th} PSFCH communication corresponding to groupcast, and P_{PSFCH,i,m} is the PSFCH transmission power for the m^{th} PSFCH communication corresponding to unicast with priority value i. In another aspect, if the sum of the transmission power for the groupcast PSFCH communications exceeds P_{CMAX}, the UE may select K+L=N_{Tx,epsfch} PSFCH communications such that N_{Tx,epsfch}≥max (1, M₁+M₂+ . . . +M_{Z}), where Mᵢ is the number of groupcast PSFCH communications corresponding to priority value i, and Z is defined as the largest value which does not cause the total transmission power of the selected PSFCH communications to exceed P_{CMAX}. In other words, Z may be defined as the largest value which satisfies the following:

$${\sum }_{i = 1}^{Z} {\sum }_{m = 1}^{{M}_{i}} {P}_{PSFCH , i , m} \leq {P}_{CMAX} \qquad ( 5 )$$

where P_{PSFCH,i,m} is the PSFCH transmission power for the m^{th} groupcast PSFCH communication with priority value i. In other aspects, Z and i may correspond to payload size, as similarly explained above. For example, in some aspects, P_{PSFCH,i,m} may be defined as the PSFCH transmission power for the m^{th} groupcast PSFCH communication having the i^{th} largest payload size Oᵢ. Further, although some of the examples described above involve groupcast PSFCH communications being selected first, in other aspects, the UE may select unicast PSFCH communications first, and groupcast communications second, if the transmission power parameters allow.

In some aspects, once the UE selects the K+L=N_{Tx,epsfch} based on the power control configurations described above, the UE may determine a transmission power for each of the selected PSFCH communications. In some aspects, the transmission power for a PSFCH communication n in a PSFCH occasion j may be determined based on the following formula:

$${P}_{PSFCH , n} ( j ) = min ( ( 10 {log}_{10} ( {M}_{PSFCH , n} ) + {P}_{CMAX} - 10 {log}_{10} ( {\sum }_{n = 1}^{{N}_{Tx , epsfch}} {M}_{PSFCH , n} ) ) , {P}_{PSFCH , one} ) \qquad ( 6 )$$

where M_{PSFCH,n} is the number of RBs occupied by PSFCH communication n, and P_{PSFCH,one} can be defined based on the formula below:

$${P}_{PSFCH , one} = {P}_{O , PSFCH} + 10 {log}_{10} ( {2}^{μ} * {M}_{PSFCH , n} ) + {α}_{PSFCH} * PL \qquad ( 7 )$$

And where P_{O,PSFCH} is the configured value of dl-P0-PSFCH, and α_{PSFCH} is the configured value of dl-Alpha-PSFCH, as explained above. PL may be defined as the DL pathloss, in decibels (dB). If dl-Alpha-PSFCH is not configured or indicated, the value of α_{PSFCH} may be 1.

In the examples provided above, actions 410 and 414 may be based on dl-P0-PSFCH being configured or enabled. In another aspect, if dl-P0-PSFCH is not enabled, the UE may select the K single-bit and L multi-bit PSFCH communications autonomously. For example, the UE may select at least one PSFCH communication for transmission in the PSFCH occasion j based on one or more rules or parameters. In one example, based on dl-P0-PSFCH not being enabled or configured, the UE selects, in action 414, the K single-bit and L multi-bit PSFCH communications, or N_{Tx,epsfch} PSFCH communications, based on an ascending order of PSFCH priority. In another example, the UE may select the N_{Tx,epsfch} PSFCH communications based on a decreasing order of PSFCH payload size. In another example, the UE may select the N_{Tx,epsfch} PSFCH communications based on an increasing order of PSFCH payload size. In another example, the UE may select the N_{Tx,epsfch} PSFCH communications based on a combination of cast type (e.g., groupcast first, unicast first), and then based on the ascending order of the PSFCH priority.

In some aspects, if dl-P0-PSFCH is not configured or enabled, the UE may determine the transmission power for the PSFCH communications selected in action 414 based on the following formula:

$${P}_{PSFCH , n} ( j ) = 10 {log}_{10} ( {M}_{PSFCH , n} ) + {P}_{CMAX} - 10 {log}_{10} ( {\sum }_{n = 1}^{{N}_{Tx , epsfch}} {M}_{PSFCH , n} ) \qquad ( 8 )$$

In some of the examples described above, the priority value associated with each PSFCH communication may be used to select one or more PSFCH communications for transmission in a PSFCH occasion. However, in some aspects, a multi-bit PSFCH communication may be associated with multiple PSSCH priority values. For example, each bit of the multi-bit PSFCH communication may correspond to two or more PSSCH communications, where each PSSCH communication is associated with a sidelink control information (SCI). Each SCI may be associated with a priority value, such as 0, 1, 2, 3, etc. In some aspects of the present disclosure, the UE may select a single priority value for a multi-bit PSFCH communication. For example, the UE may select a priority value of a multi-bit PSFCH communication based on a smallest priority value of the SCI associated with the multi-bit PSFCH communication. In some aspects, by determining the multi-bit PSFCH priority value based on the last-received SCI, the sidelink UE receiving the multi-bit PSFCH may determine whether an SCI was missed based on the PSFCH resource and the code block size associated with the PSFCH communication.

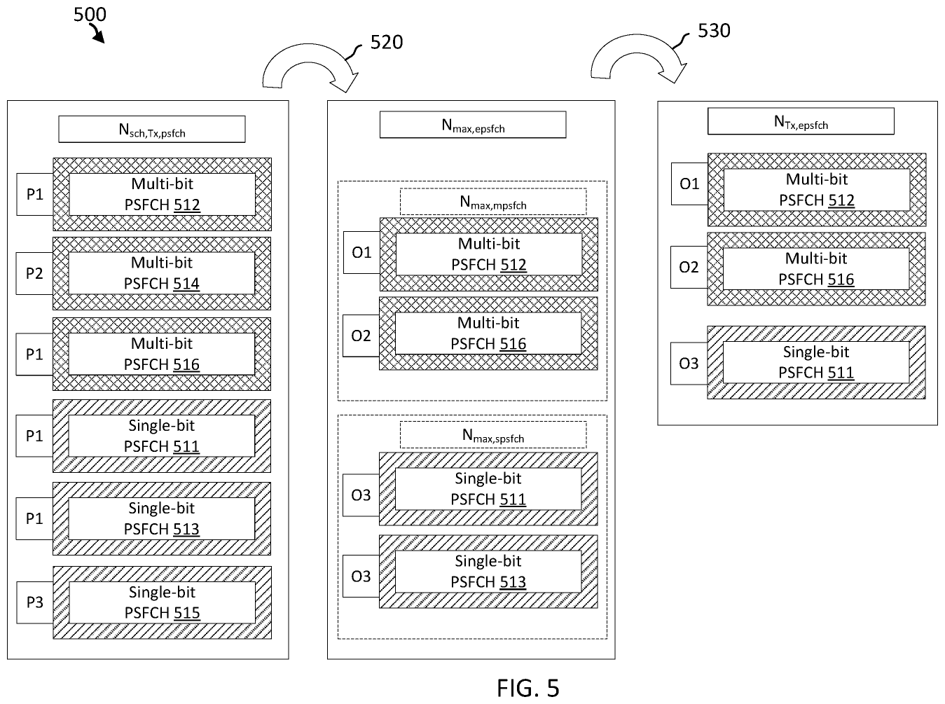

FIG. 5 is a diagram illustrating a method for multiplexing and transmitting a combination of multi-bit and single-bit PSFCH communications, according to some aspects of the present disclosure. The method 500 may be performed by a UE, such as one of the UEs 115 of the network 100, one of the UEs 302, or the UE 304. The method 500 may include one or more aspects of the methods 300 and/or 400.

Referring to FIG. 5, the method 500 includes a two-tiered selection procedure to select, from a plurality of scheduled PSFCH communications (N_{sch,Tx,psfch}) associated with a PSFCH occasion j, a set of PSFCH communications for transmission (N_{Tx,epsfch}), where the N_{Tx,epsfch} PSFCH communications may include one or more single-bit PSFCH communications, and one or more multi-bit PSFCH communications. As shown, the method 500 includes a first selection 520 for selecting, from the N_{sch,Tx,psfch} scheduled PSFCH communications, one or more sets (e.g., N_{max,epsfch}) of PSFCH communications based on UE PSFCH capabilities or configurations. For example, in some aspects, the selecting the subset N_{max,espsfch} PSFCH communications may correspond to actions 402 and 406 of the method 400. In some aspects, selecting the N_{max,espsfch} PSFCH communications includes selecting N_{max,sspsfch} single-bit PSFCH communications, and N_{max,mspsfch} multi-bit PSFCH communications. The selection may be based on one or more configured maximum numbers. For example, N_{max,epsfch} may be indicated in a PSFCH capability configuration and indicates combined total number of PSFCH communications including single-bit PSFCH communications and multi-bit PSFCH communications. In another example, N_{max,spsfch} may be indicated in the PSFCH capability configuration and may indicate a maximum number of single-bit PSFCH communications that can be transmitted in the PSFCH occasion j. In another example, N_{max,mpsfch} may be indicated in the PSFCH capability configuration and may indicate a maximum number of multi-bit PSFCH communications that can be transmitted in the PSFCH occasion j. In some aspects, the UE may select one or more subsets of PSFCH communications based on a combination of the maximum numbers, as described above with respect to FIGS. 3 and 4.

In the illustrated example, each PSFCH communication, including the multi-bit PSFCH communications 512, 514, 516, and the single-bit PSFCH communications 511, 513, 515, is associated with a priority value (e.g., P1, P2, P3). In another aspect, each of the PSFCH communications may be associated with a payload size (e.g., O1, O2, O3 etc.), a cast type (e.g., unicast, multicast, groupcast, etc.), and/or any other type of parameter. In FIG. 5, the first selection 520 may be performed based on an ascending priority value, such that the P1 PSFCH communications 512, 516, 511, 513 are selected based on the configured N_{max,epsfch}, N_{max,mpsfch}, and/or N_{max,spsfch}.

In the second selection 530, the UE determines the number of PSFCH for transmission (N_{Tx,epsfch}) based on the power configurations. In some aspects, the UE may determine or select the number of PSFCH for transmission based on payload of each PSFCH Oᵢ. In some aspects, the second selection may include the aspects described above with respect to steps 408, 410, and 414 of the method 400. In this regard, the selection of the N_{Tx,epsfch}, including a first number of single-bit PSFCH communications and a second number of multi-bit PSFCH communications, may be based on whether dl-P0-PSFCH is enabled or configured. In the illustrated example, the second selection is based on the payload size and the total transmission power of PSFCH 512 corresponding to payload size O1 and PSFCH 516 corresponding to payload size O2 may be less than P_{CMAX}. Therefore, the UE may select two PSFCH communications or more than two PSFCH communications for transmission. In the illustrated example, the PSFCH communication 512 corresponding to payload size O1, PSFCH communication 516 corresponding to payload size O2, and PSFCH communication 511 corresponding to payload size O3 are selected for transmission. In some aspects, once the UE has selected the N_{Tx,epsfch} PSFCH communications, including the first number of single-bit PSFCH communications and the second number of multi-bit PSFCH communications, the UE may determine, for each selected PSFCH communication in the PSFCH occasion j, a transmission power as described above.

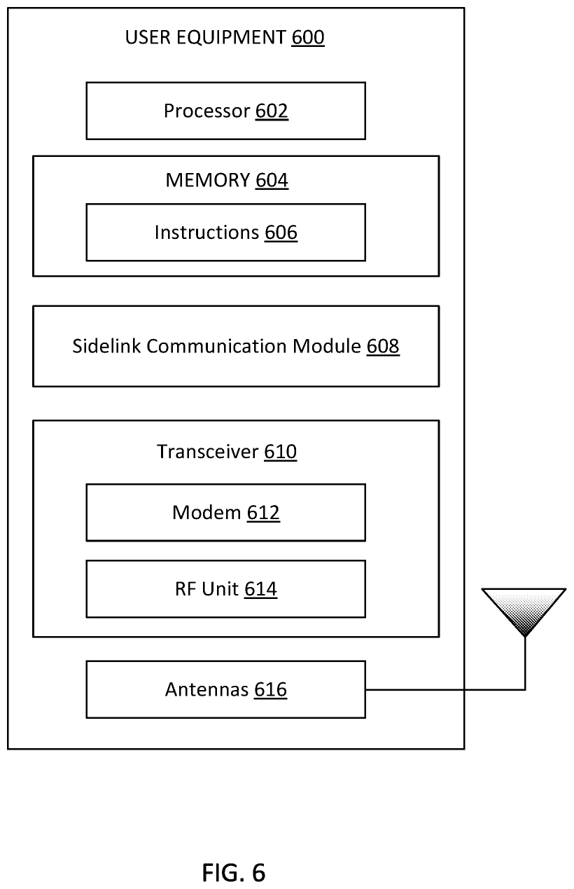

FIG. 6 is a block diagram of an exemplary UE 600 according to some aspects of the present disclosure. The UE 600 may be a UE 115 discussed above in FIG. 1. As shown, the UE 600 may include a processor 602, a memory 604, an sidelink communication module 608, a transceiver 610 including a modem subsystem 612 and a radio frequency (RF) unit 614, and one or more antennas 616. These elements may be in direct or indirect communication with each other, for example via one or more buses.

The processor 602 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 602 may also be implemented as a combination of computing devices, e.g., a combination of a DSP and a microprocessor, a plurality of microprocessors, one or more microprocessors in conjunction with a DSP core, or any other such configuration.

The memory 604 may include a cache memory (e.g., a cache memory of the processor 602), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In an aspect, the memory 604 includes a non-transitory computer-readable medium. The memory 604 may store, or have recorded thereon, instructions 606. The instructions 606 may include instructions that, when executed by the processor 602, cause the processor 602 to perform the operations described herein with reference to the UEs 115 in connection with aspects of the present disclosure, for example, aspects of FIGS. 5-10. Instructions 606 may also be referred to as program code. The program code may be for causing a wireless communication device to perform these operations, for example by causing one or more processors (such as processor 602) to control or command the wireless communication device to do so. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The sidelink communication module 608 may be implemented via hardware, software, or combinations thereof. For example, the sidelink communication module 608 may be implemented as a processor, circuit, and/or instructions 606 stored in the memory 604 and executed by the processor 602. In some instances, the sidelink communication module 608 can be integrated within the modem subsystem 612. For example, the sidelink communication module 608 can be implemented by a combination of software components (e.g., executed by a DSP or a general processor) and hardware components (e.g., logic gates and circuitry) within the modem subsystem 612.

The sidelink communication module 608 may be used for various aspects of the present disclosure, for example, aspects of FIGS. 3-5 and 8. The sidelink communication module 608 is configured to select and transmit, based on a PSFCH capability configuration, a first number of single-bit PSFCH communications, and a second number of multi-bit PSFCH communications. For example, the sidelink communication module 608 may be configured to receive, from one or more UEs, an indication to transmit a plurality of PSFCH communications including one or more single-bit PSFCH communications and one or more multi-bit PSFCH communications. In some aspects, the sidelink communication module 608 receiving the indication to transmit the plurality of PSFCH communications includes the sidelink communication module 608 receiving a plurality of sidelink communications in a plurality of physical sidelink shared channels (PSSCHs). In some aspects, each of the PSSCH communications may be associated with a sidelink control information (SCI), a priority, and/or a cast type. In some aspects, the SCI for each PSSCH may indicate, to the first UE, the priority value of the PSSCH communication, the cast type (e.g., unicast, groupcast, multicast, etc.), the order in which the SCI was received, and/or any other suitable parameter. As explained below, one or more of the parameters indicated in the SCI may be used by the sidelink communication module 608 to select a first number of single-bit PSFCH communications and a second number of multi-bit PSFCH communications for transmission to the one or more UEs.

In another aspect, the sidelink communication module may be configured to transmit, to the one or more UEs based on the indication in a single PSFCH occasion, a first number of single-bit PSFCH communications of the one or more single-bit PSFCH communications, and a second number of multi-bit PSFCH communications of the one or more multi-bit PSFCH communications, where the first number of single-bit PSFCH communications and the second number of multi-bit PSFCH communications are based on a PSFCH capability configuration. In some aspects, the PSFCH capability configuration is statically configured or preconfigured at the sidelink communication module 608. In one example, the PSFCH capability configuration may be stored in a memory 604 of the UE 600. In other aspects, the PSFCH capability configuration may be semi-statically and/or dynamically configured at the sidelink communication module 608 using radio resource control (RRC) messages, media access control (MAC) information elements, MAC control elements, downlink control information (DCI), and/or any other suitable control signaling. In some aspects, the PSFCH capability configuration may include a combination of statically, semi-statically, and/or dynamically configured parameters and values.

It will be understood that the first number of single-bit PSFCH communications may include any positive integer value, including 0, 1, 2, 3, 4, 5, 8, 10, or any other suitable value. Additionally, the second number of multi-bit PSFCH communications may include any positive integer value, including 0, 1, 2, 3, 4, 5, 8, 10, or any other suitable value. The sidelink communication module 608 may simultaneously transmit PSFCH communications in the PSFCH occasion for one or more cast types, such as unicast or groupcast. In some aspects, based on the PSFCH capability configuration, the sidelink communication module 608 may transmit all of the PSFCH communications, including the single-bit PSFCH communications and the multi-bit PSFCH communications, that are scheduled for the PSFCH occasion. In other aspects, the sidelink communication module 608 selects, based on the PSFCH capability configuration as explained above with respect to FIGS. 3-5, a subset of one or more PSFCH communications based on UE capability and PSFCH power control configurations. In this regard, it will be understood that the sidelink communication module 608 may be configured to perform one or more steps of the method 400 described above with respect to FIG. 4, for example.

In some aspects, the transmitting the first number of single-bit PSFCH communications and the second number of multi-bit PSFCH communications includes frequency domain multiplexing the PSFCH communications within the periodic resources allocated for the PSFCH. The PSFCH resources may be aligned in the time domain to one symbol, two symbols, or three symbols, for example. In some aspects, each PSFCH communication may be allocated a resource block (RB). In another aspect, one or more PSFCH communications may each be allocated more than RB. For example, a multi-bit PSFCH communication may be allocated two or more RBs, in some aspects. In another aspect, two or more PSFCH communications may share an RB (e.g., 6 subcarriers each, 3 subcarriers each, 4 subcarriers each, etc.). In some aspects, the first UE may transmit one or more of the PSFCH communications based on a PUCCH format 0.

As shown, the transceiver 610 may include the modem subsystem 612 and the RF unit 614. The transceiver 610 can be configured to communicate bi-directionally with other devices, such as the BSs 105 and other UEs 115 (e.g., via sidelinks). The modem subsystem 612 may be configured to modulate and/or encode the data from the memory 604 and/or the sidelink communication module 608 according to a modulation and coding scheme (MCS), e.g., a low-density parity check (LDPC) coding scheme, a turbo coding scheme, a convolutional coding scheme, a digital beamforming scheme, etc. The RF unit 614 may be configured to process (e.g., perform analog to digital conversion or digital to analog conversion, etc.) modulated/encoded data (e.g., PSSCH data and/or PSCCH control information, PSFCH capability configuration information, HARQ ACK/NACK) from the modem subsystem 612 (on outbound transmissions) or of transmissions originating from another source such as a UE 115 or a BS 105. The RF unit 614 may be further configured to perform analog beamforming in conjunction with the digital beamforming. Although shown as integrated together in transceiver 610, the modem subsystem 612 and the RF unit 614 may be separate devices that are coupled together at the UE 115 to enable the UE 115 to communicate with other devices.

The RF unit 614 may provide the modulated and/or processed data, e.g. data packets (or, more generally, data messages that may contain one or more data packets and other information), to the antennas 616 for transmission to one or more other devices. The antennas 616 may further receive data messages transmitted from other devices (e.g., groupcast and/or unicast messages concurrently). The antennas 616 may provide the received data messages for processing and/or demodulation at the transceiver 610. The transceiver 610 may provide the demodulated and decoded data (e.g., PSSCH data and/or PSCCH control information, PSFCH capability configuration information, HARQ ACK/NACK) to the sidelink communication module 608 for processing. The antennas 616 may include multiple antennas of similar or different designs in order to sustain multiple transmission links. The RF unit 614 may configure the antennas 616.

In an aspect, the UE 600 can include multiple transceivers 610 implementing different RATs (e.g., NR and LTE). In an aspect, the UE 600 can include a single transceiver 610 implementing multiple RATs (e.g., NR and LTE). In an aspect, the transceiver 610 can include various components, where different combinations of components can implement different RATs.

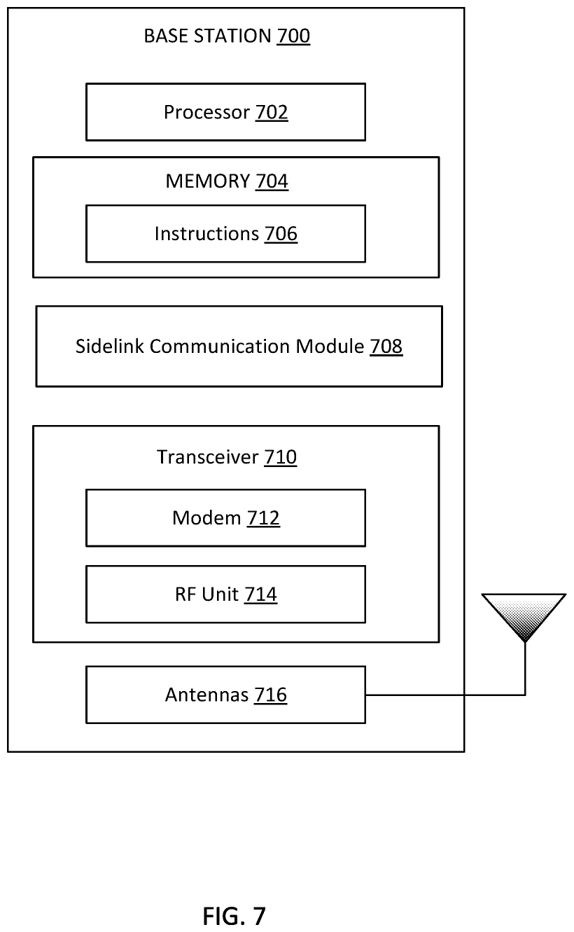

FIG. 7 is a block diagram of an exemplary BS 700 according to some aspects of the present disclosure. The BS 700 may be a BS 105 in the network 100 as discussed above in FIG. 1. A shown, the BS 700 may include a processor 702, a memory 704, an sidelink communication module 708, a transceiver 710 including a modem subsystem 712 and a RF unit 714, and one or more antennas 716. These elements may be in direct or indirect communication with each other, for example via one or more buses.

The processor 702 may have various features as a specific-type processor. For example, these may include a CPU, a DSP, an ASIC, a controller, a FPGA device, another hardware device, a firmware device, or any combination thereof configured to perform the operations described herein. The processor 702 may also be implemented as a combination of computing devices, e.g., a combination of a DSP and a microprocessor, a plurality of microprocessors, one or more microprocessors in conjunction with a DSP core, or any other such configuration.

The memory 704 may include a cache memory (e.g., a cache memory of the processor 702), RAM, MRAM, ROM, PROM, EPROM, EEPROM, flash memory, a solid state memory device, one or more hard disk drives, memristor-based arrays, other forms of volatile and non-volatile memory, or a combination of different types of memory. In some aspects, the memory 704 may include a non-transitory computer-readable medium. The memory 704 may store instructions 706. The instructions 706 may include instructions that, when executed by the processor 702, cause the processor 702 to perform operations described herein. Instructions 706 may also be referred to as code, which may be interpreted broadly to include any type of computer-readable statement(s) as discussed above with respect to FIG. 3.

The sidelink communication module 708 may be implemented via hardware, software, or combinations thereof. For example, the sidelink communication module 708 may be implemented as a processor, circuit, and/or instructions 706 stored in the memory 704 and executed by the processor 702. In some instances, the sidelink communication module 708 can be integrated within the modem subsystem 712. For example, the sidelink communication module 708 can be implemented by a combination of software components (e.g., executed by a DSP or a general processor) and hardware components (e.g., logic gates and circuitry) within the modem subsystem 712. The sidelink communication module 708 may be configured to configured to configure a pool of sidelink resources for sidelink UEs (e.g., the UEs 115, 215, 302, 304 and/or 600) for sidelink communications (e.g., PSSCH, PSCCH) and/or a pool of sidelink ACK/NACK resources for PSFCH communications, and/or transmit a sidelink resource configuration to the sidelink UEs. The sidelink resource configuration may indicate a time, a periodicity, and/or a frequency band where the sidelink UEs may contend for COTs for sidelink communication (e.g., PSSCH/PSCCH/PSFCH). In some aspects, the sidelink communication module 708 is configured to receive a sidelink resource request from the sidelink UE and the sidelink resource configuration may be transmitted in response to the request.

As shown, the transceiver 710 may include the modem subsystem 712 and the RF unit 714. The transceiver 710 can be configured to communicate bi-directionally with other devices, such as the UEs 115 and/or 600 and/or another core network element. The modem subsystem 712 may be configured to modulate and/or encode data according to a MCS, e.g., a LDPC coding scheme, a turbo coding scheme, a convolutional coding scheme, a digital beamforming scheme, etc. The RF unit 714 may be configured to process (e.g., perform analog to digital conversion or digital to analog conversion, etc.) modulated/encoded data (e.g., sidelink resource configuration) from the modem subsystem 712 (on outbound transmissions) or of transmissions originating from another source such as a UE 115 and/or UE 600. The RF unit 714 may be further configured to perform analog beamforming in conjunction with the digital beamforming. Although shown as integrated together in transceiver 710, the modem subsystem 712 and/or the RF unit 714 may be separate devices that are coupled together at the BS 700 to enable the BS 700 to communicate with other devices.

The RF unit 714 may provide the modulated and/or processed data, e.g. data packets (or, more generally, data messages that may contain one or more data packets and other information), to the antennas 716 for transmission to one or more other devices. This may include, for example, transmission of information to complete attachment to a network and communication with a camped UE 115 or 600 according to some aspects of the present disclosure. The antennas 716 may further receive data messages transmitted from other devices and provide the received data messages for processing and/or demodulation at the transceiver 710. The transceiver 710 may provide the demodulated and decoded data (e.g., a sidelink resource configuration request) to the sidelink communication module 708 for processing. The antennas 716 may include multiple antennas of similar or different designs in order to sustain multiple transmission links.

In an example, the transceiver 710 is configured to transmit a resource configuration to a UE (e.g., the UEs 115 and 300) and receive a UL control channel signal (e.g., a PUCCH signal) modulated by HARQ ACK/NACK and SR from the UE 600, for example, by coordinating with the sidelink communication module 708.

In an aspect, the BS 700 can include multiple transceivers 710 implementing different RATs (e.g., NR and LTE). In an aspect, the BS 700 can include a single transceiver 710 implementing multiple RATs (e.g., NR and LTE). In an aspect, the transceiver 710 can include various components, where different combinations of components can implement different RATs.

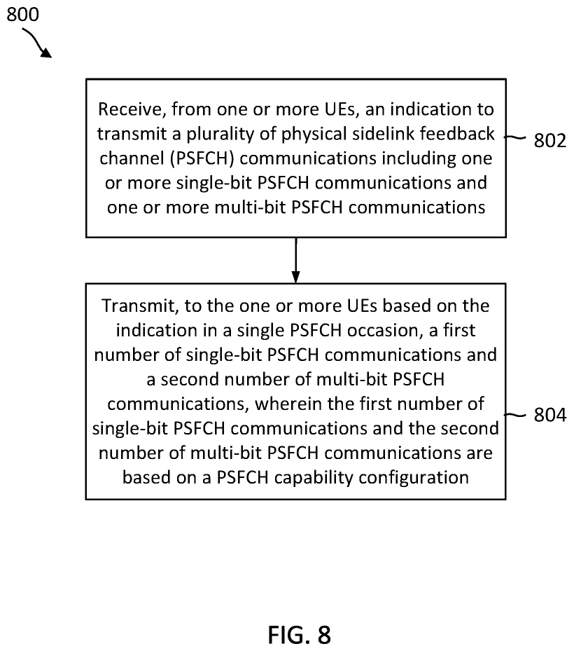

FIG. 8 illustrates a flow diagram of a wireless communication method 800 according to some embodiments of the present disclosure. Aspects of the method 800 may be executed by a wireless communication device, such as the UEs 115, 215, 302, 304, and/or 600 utilizing one or more components, such as the processor 602, the memory 604, the sidelink communication module 608, the transceiver 610, the modem 612, the one or more antennas 616, and various combinations thereof. As illustrated, the method 800 includes a number of enumerated steps, but embodiments of the method 800 may include additional steps before, during, after, and in between the enumerated steps. Further, in some embodiments, one or more of the enumerated steps may be omitted or performed in a different order.

At block 802, a first UE receives, from one or more UEs, an indication to transmit a plurality of physical sidelink feedback channel (PSFCH) communications including one or more single-bit PSFCH communications and one or more multi-bit PSFCH communications. In some aspects, receiving the indication to transmit the plurality of PSFCH communications includes receiving a plurality of sidelink communications in a plurality of physical sidelink shared channels (PSSCHs). In some aspects, each of the PSSCH communications may be associated with a sidelink control information (SCI), a priority, and/or a cast type. In some aspects, the SCI for each PSSCH may indicate, to the first UE, the priority value of the PSSCH communication, the cast type (e.g., unicast, groupcast, multicast, etc.), the order in which the SCI was received, and/or any other suitable parameter. As explained below, one or more of the parameters indicated in the SCI may be used by the first UE to select a first number of single-bit PSFCH communications and a second number of multi-bit PSFCH communications for transmission to the one or more UEs. The UE 600 may use one or more components, such as the processor 602, the memory 604, the sidelink communication module 608, the transceiver 610, and/or the antennas 616, to perform the actions of block 802.

At block 804, the first UE transmits, to the one or more UEs based on the indication in a single PSFCH occasion, a first number of single-bit PSFCH communications of the one or more single-bit PSFCH communications, and a second number of multi-bit PSFCH communications of the one or more multi-bit PSFCH communications, where the first number of single-bit PSFCH communications and the second number of multi-bit PSFCH communications are based on a PSFCH capability configuration. In some aspects, the PSFCH capability configuration is statically configured or preconfigured at the first UE. For example, the PSFCH capability configuration may be stored in a memory 604 of the UE 600. In other aspects, the PSFCH capability configuration may be semi-statically and/or dynamically configured at the first UE using radio resource control (RRC) messages, media access control (MAC) information elements, MAC control elements, downlink control information (DCI), and/or any other suitable control signaling. In some aspects, the PSFCH capability configuration may include a combination of statically, semi-statically, and/or dynamically configured parameters and values. The UE 600 may use one or more components, such as the processor 602, the memory 604, the sidelink communication module 608, the transceiver 610, and/or the antennas 616, to perform the actions of block 804.

It will be understood that the first number of single-bit PSFCH communications may include any positive integer value, including 0, 1, 2, 3, 4, 5, 8, 10, or any other suitable value. Additionally, the second number of multi-bit PSFCH communications may include any positive integer value, including 0, 1, 2, 3, 4, 5, 8, 10, or any other suitable value. The first UE may simultaneously transmit PSFCH communications in the PSFCH occasion for one or more cast types, such as unicast or groupcast. In some aspects, based on the PSFCH capability configuration, the UE may transmit all of the PSFCH communications, including the single-bit PSFCH communications and the multi-bit PSFCH communications, that are scheduled for the PSFCH occasion. In other aspects, the UE selects, based on the PSFCH capability configuration as explained above with respect to FIGS. 3-5, a subset of one or more PSFCH communications based on UE capability and PSFCH power control configurations. In this regard, it will be understood that block 804 may include performing one or more steps of the method 400 described above with respect to FIG. 4, for example.

In some aspects, the transmitting the first number of single-bit PSFCH communications and the second number of multi-bit PSFCH communications includes frequency domain multiplexing the PSFCH communications within the periodic resources allocated for the PSFCH. The PSFCH resources may be aligned in the time domain to one symbol, two symbols, or three symbols, for example. In some aspects, each PSFCH communication may be allocated a resource block (RB). In another aspect, one or more PSFCH communications may each be allocated more than one RB. For example, a multi-bit PSFCH communication may be allocated two or more RBs, in some aspects. In another aspect, two or more PSFCH communications may share an RB (e.g., 6 subcarriers each, 3 subcarriers each, 4 subcarriers each, etc.). In some aspects, the first UE may transmit one or more of the PSFCH communications based on a PUCCH format 0.

In some aspects, the PSFCH capability configuration indicates a maximum number of simultaneously PSFCH transmissions that can be transmitted in the single PSFCH occasion. In some aspects, the method 800 further includes the first UE selecting, by the first UE based on the PSFCH capability configuration, a third number of single-bit PSFCH communications and a fourth number of multi-bit PSFCH communications, wherein the selecting is based on the maximum number of simultaneous PSFCH transmissions and one or more of: a PSFCH communication ordering of the plurality of PSFCH communications; a payload size of each of the plurality of PSFCH communications; a cast type of each of the plurality of PSFCH communications; or a priority of each of the plurality of PSFCH communications.

In some aspects, the PSFCH capability configuration indicates a first maximum number of simultaneous single-bit PSFCH transmissions and a second maximum number of simultaneous multi-bit PSFCH transmissions. In some aspects, the method 800 further includes: selecting, by the first UE based on the PSFCH capability configuration, a third number of single-bit PSFCH communications, wherein the selecting is based on the first maximum number of simultaneous single-bit PSFCH transmissions and one or more of: a PSFCH communication ordering of the one or more single-bit PSFCH communications; a payload size of each of the one or more single-bit PSFCH communications a cast type of each of the one or more single-bit PSFCH communications; or a priority of each of the one or more single-bit PSFCH communications, wherein the first number of single-bit PSFCH communications is based on the third number of PSFCH communications. In some aspects, the method 800 further includes: selecting, by the first UE based on the PSFCH capability configuration, a fourth number of multi-bit PSFCH communications, wherein the selecting is based on the second maximum number of simultaneous multi-bit PSFCH transmissions and one or more of: a PSFCH communication ordering of the one or more multi-bit PSFCH communications; a payload size of each of the one or more multi-bit PSFCH communications; a cast type of each of the one or more multi-bit PSFCH communications; or a priority of each of the one or more multi-bit PSFCH communications, wherein the second number of multi-bit PSFCH communications is based on the fourth number of PSFCH communications.

In another aspect, the PSFCH capability configuration further indicates a first maximum number of simultaneous single-bit PSFCH transmissions, a second maximum number of simultaneous multi-bit PSFCH transmissions, and a combined maximum number of simultaneous single-bit and multi-bit PSFCH transmissions. In another aspect, the method 800 further includes: selecting, by the first UE based on the PSFCH capability configuration, a third number of single-bit PSFCH communications, wherein the selecting is based on the first maximum number of simultaneous single-bit PSFCH transmissions and one or more of: a PSFCH communication ordering of the one or more single-bit PSFCH communications; a payload size of each of the one or more single-bit PSFCH communications; a cast type of each of the one or more single-bit PSFCH communications; or a priority of each of the one or more single-bit PSFCH communications, wherein the first number of single-bit PSFCH communications is based on the third number of PSFCH communications. In another aspect, the method 800 further includes: selecting, by the first UE based on the PSFCH capability configuration, a fourth number of multi-bit PSFCH communications, wherein the selecting is based on the second maximum number of simultaneous multi-bit PSFCH transmissions and one or more of: a PSFCH communication ordering of the one or more multi-bit PSFCH communications; a payload size of each of the one or more multi-bit PSFCH communications; a cast type of each of the one or more multi-bit PSFCH communications; or a priority of each of the one or more multi-bit PSFCH communications, wherein the second number of single-bit PSFCH communications is based on the fourth number of multi-bit PSFCH communications. In another aspect, the method 800 further includes: selecting, by the first UE based on the PSFCH capability configuration, a fifth number of PSFCH communications from the third number of single-bit PSFCH communications and the fourth number of multi-bit PSFCH communications, wherein the selecting is based on the combined maximum number of simultaneous single-bit and multi-bit PSFCH transmissions and one or more of: a PSFCH communication ordering of the fifth number of PSFCH communications; a payload size of each of the fifth number of PSFCH communications; a cast type of each of the fifth number of PSFCH communications; or a priority of each of the fifth number of PSFCH communications, wherein the first number of single-bit PSFCH communications and the second number of multi-bit PSFCH communications are based on the fifth number of PSFCH communications.

In a further aspect of the present disclosure, the PSFCH capability configuration indicates a maximum PSFCH transmission power parameter, and the first number of single-bit PSFCH communications and the second number of multi-bit PSFCH communications are based on the maximum PSFCH transmission power parameter. In another aspect of the present disclosure, the PSFCH capability configuration further indicates whether a downlink (DL) pathloss-based power control parameter is enabled, and wherein the first number of single-bit PSFCH communications and the second number of multi-bit PSFCH communications are based on whether the DL pathloss-based power control parameter is enabled. In another aspect of the present disclosure, the PSFCH capability configuration indicates a first maximum number of simultaneous PSFCH transmissions, and wherein the method 800 further comprises: selecting, based on a maximum number of simultaneous PSFCH communications indicated in the PSFCH capability configuration, a first set of the plurality of PSFCH communications; and determining that the first set of the plurality of PSFCH communications is equal to the maximum number of simultaneous PSFCH transmissions, wherein the determining is based on a total transmission power of the first set of the plurality of PSFCH communications being less than or equal to the maximum PSFCH transmission power parameter.

In another aspect of the present disclosure, the method 800 further includes: selecting, based on at least one maximum number of simultaneous PSFCH communications indicated in the PSFCH capability configuration, a first set of the plurality of PSFCH communications; and selecting, based on a total transmission power of the first set of the plurality of PSFCH communications exceeding the maximum PSFCH transmission power parameter, a second set of the plurality of PSFCH communications including the first number of single-bit PSFCH communications and the second number of multi-bit PSFCH communications, wherein the selecting the second set of the plurality of PSFCH communications is based on at least one of: a cast type of each PSFCH communication of the plurality of PSFCH communications; a priority of each PSFCH communication of the plurality of PSFCH communications; or a payload of each PSFCH communication of the plurality of PSFCH communications. In another aspect of the present disclosure, a number of the second set of the plurality of PSFCH communications is equal to or larger than a lower bound.

In another aspect of the present disclosure, the method 800 further includes: selecting, based on at least one maximum number of simultaneous PSFCH communications indicated in the PSFCH capability configuration, a first set of the plurality of PSFCH communications; and determining, based on a total transmission power of the first set of the plurality of PSFCH communications exceeding the maximum PSFCH transmission power parameter, a second set of the plurality of PSFCH communications including the first number of single-bit PSFCH communications and the second number of multi-bit PSFCH communications, wherein the transmitting each PSFCH communication of the second set of the plurality of PSFCH communications comprises transmitting each PSFCH communication of the second set of the plurality of PSFCH communications based on a corresponding transmission power, wherein the corresponding transmission power for a PSFCH communication of the second set of the plurality of PSFCH communications is based on one or more of: a transmission power per resource block; a number of resource blocks allocated to the PSFCH communication; the DL pathloss-based power control parameter, wherein the DL pathloss-based power control parameter indicates a P0 value, an alpha value, and a number of resource blocks allocated to the PSFCH communication.

In another aspect of the present disclosure, at least the second number of multi-bit PSFCH communications is based on a corresponding multi-bit priority value associated with each of the second number of multi-bit PSFCH communications, wherein at least one of the second number of multi-bit PSFCH communications comprises a plurality of bits, each bit associated with a single-bit priority value, and wherein the corresponding priority value for the at least one of the second number of multi-bit PSFCH communications is based on a smallest single-bit priority value associated with a corresponding multi-bit PSFCH communication. In another aspect of the present disclosure, at least the second number of multi-bit PSFCH communications is based on a corresponding multi-bit priority value associated with each of the second number of multi-bit PSFCH communications, wherein at least one PSFCH communication of the second number of multi-bit PSFCH communications comprises a plurality of bits, each bit associated with a single-bit priority value, and wherein the corresponding priority value for the at least one of the second number of multi-bit PSFCH communications is based on a priority value indicated in a most recent sidelink control information (SCI) scheduling a PSSCH associated with the corresponding multi-bit PSFCH communication.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

### EXEMPLARY ASPECTS OF THE PRESENT DISCLOSURE

Aspect 1. A method of wireless communication performed by a first user equipment (UE), the method comprising: receiving, from one or more UEs, an indication to transmit a plurality of physical sidelink feedback channel (PSFCH) communications including one or more single-bit PSFCH communications and one or more multi-bit PSFCH communications; transmitting, to the one or more UEs based on the indication in a single PSFCH occasion, a first number of single-bit PSFCH communications of the one or more single-bit PSFCH communications, and a second number of multi-bit PSFCH communications of the one or more multi-bit PSFCH communications, wherein the first number of single-bit PSFCH communications and the second number of multi-bit PSFCH communications are based on a PSFCH capability configuration.

Aspect 2. The method of aspect 1, wherein the PSFCH capability configuration indicates a maximum number of simultaneous PSFCH transmissions.

Aspect 3. The method of aspect 2, further comprising: selecting, by the first UE based on the PSFCH capability configuration, a third number of single-bit PSFCH communications and a fourth number of multi-bit PSFCH communications, wherein the selecting is based on the maximum number of simultaneous PSFCH transmissions and one or more of: a PSFCH communication ordering of the plurality of PSFCH communications; a payload size of each of the plurality of PSFCH communications; a cast type of each of the plurality of PSFCH communications; or a priority of each of the plurality of PSFCH communications.

Aspect 4. The method of aspect 1, wherein the PSFCH capability configuration indicates a first maximum number of simultaneous single-bit PSFCH transmissions and a second maximum number of simultaneous multi-bit PSFCH transmissions.

Aspect 5. The method of any of aspect 4, further comprising: selecting, by the first UE based on the PSFCH capability configuration, a third number of single-bit PSFCH communications, wherein the selecting is based on the first maximum number of simultaneous single-bit PSFCH transmissions and one or more of: a PSFCH communication ordering of the one or more single-bit PSFCH communications; a payload size of each of the one or more single-bit PSFCH communications a cast type of each of the one or more single-bit PSFCH communications; or a priority of each of the one or more single-bit PSFCH communications, wherein the first number of single-bit PSFCH communications is based on the third number of PSFCH communications.

Aspect 6. The method of any of aspects 4 or 5, further comprising: selecting, by the first UE based on the PSFCH capability configuration, a fourth number of multi-bit PSFCH communications, wherein the selecting is based on the second maximum number of simultaneous multi-bit PSFCH transmissions and one or more of: a PSFCH communication ordering of the one or more multi-bit PSFCH communications; a payload size of each of the one or more multi-bit PSFCH communications; a cast type of each of the one or more multi-bit PSFCH communications; or a priority of each of the one or more multi-bit PSFCH communications, wherein the second number of multi-bit PSFCH communications is based on the fourth number of PSFCH communications.

Aspect 7. The method of aspect 1, wherein the PSFCH capability configuration indicates a first maximum number of simultaneous single-bit PSFCH transmissions and a second maximum number of simultaneous multi-bit PSFCH transmissions and a combined maximum number of simultaneous single-bit and multi-bit PSFCH transmissions.

Aspect 8. The method of aspect 7, further comprising: selecting, by the first UE based on the PSFCH capability configuration, a third number of single-bit PSFCH communications, wherein the selecting is based on the first maximum number of simultaneous single-bit PSFCH transmissions and one or more of: a PSFCH communication ordering of the one or more single-bit PSFCH communications; a payload size of each of the one or more single-bit PSFCH communications; a cast type of each of the one or more single-bit PSFCH communications; or a priority of each of the one or more single-bit PSFCH communications, wherein the first number of single-bit PSFCH communications is based on the third number of PSFCH communications.

Aspect 9. The method of aspect 8, further comprising: selecting, by the first UE based on the PSFCH capability configuration, a fourth number of multi-bit PSFCH communications, wherein the selecting is based on the second maximum number of simultaneous multi-bit PSFCH transmissions and one or more of: a PSFCH communication ordering of the one or more multi-bit PSFCH communications; a payload size of each of the one or more multi-bit PSFCH communications; a cast type of each of the one or more multi-bit PSFCH communications; or a priority of each of the one or more multi-bit PSFCH communications, wherein the second number of single-bit PSFCH communications is based on the fourth number of multi-bit PSFCH communications.

Aspect 10. The method of aspect 9, further comprising: selecting, by the first UE based on the PSFCH capability configuration, a fifth number of PSFCH communications from the third number of single-bit PSFCH communications and the fourth number of multi-bit PSFCH communications, wherein the selecting is based on the combined maximum number of simultaneous single-bit and multi-bit PSFCH transmissions and one or more of: a PSFCH communication ordering of the fifth number of PSFCH communications; a payload size of each of the fifth number of PSFCH communications; a cast type of each of the fifth number of PSFCH communications; or a priority of each of the fifth number of PSFCH communications, wherein the first number of single-bit PSFCH communications and the second number of multi-bit PSFCH communications are based on the fifth number of PSFCH communications.

Aspect 11. The method of any of aspects 1-10, wherein the PSFCH capability configuration indicates a maximum PSFCH transmission power parameter, and wherein the first number of single-bit PSFCH communications and the second number of multi-bit PSFCH communications are based on the maximum PSFCH transmission power parameter.

Aspect 12. The method of aspect 11, wherein the PSFCH capability configuration further indicates whether a downlink (DL) pathloss-based power control parameter is enabled, and wherein the first number of single-bit PSFCH communications and the second number of multi-bit PSFCH communications are based on whether the DL pathloss-based power control parameter is enabled.

Aspect 13. The method of aspect 12, wherein the PSFCH capability configuration indicates a first maximum number of simultaneous PSFCH transmissions, and wherein the method further comprises: determining that at least one of the first number of single-bit PSFCH communications or the second number of multi-bit PSFCH communications is equal to the first maximum number of simultaneous PSFCH transmissions, wherein the determining is based on a total transmission power of the first number of PSFCH communications and the fourth number of PSFCH communications associated with the single PSFCH occasion is less than or equal to the maximum PSFCH transmission power parameter.

Aspect 14. The method of aspect 12, further comprising: selecting, based on at least one maximum number of simultaneous PSFCH communications indicated in the PSFCH capability configuration, a first set of the plurality of PSFCH communications; and selecting, based on a total transmission power of the first set of the plurality of PSFCH communications exceeding the maximum PSFCH transmission power parameter, a second set of the plurality of PSFCH communications including the first number of single-bit PSFCH communications and the second number of multi-bit PSFCH communications, wherein the determining the second set of the plurality of PSFCH communications is based on at least one of: a cast type of each PSFCH communication of the plurality of PSFCH communications; a priority of each PSFCH communication of the plurality of PSFCH communications; or a payload of each PSFCH communication of the plurality of PSFCH communications.

Aspect 15. The method of aspect 14, wherein a number of the second set of the plurality of PSFCH communications is equal to or larger than a lower bound.

Aspect 16. The method of aspect 12, further comprising: selecting, based on at least one maximum number of simultaneous PSFCH communications indicated in the PSFCH capability configuration, a first set of the plurality of PSFCH communications; and determining, based on a total transmission power of the first set of the plurality of PSFCH communications exceeding the maximum PSFCH transmission power parameter, a second set of the plurality of PSFCH communications including the first number of single-bit PSFCH communications and the second number of multi-bit PSFCH communications, wherein the transmitting each PSFCH communication of the second set of the plurality of PSFCH communications comprises transmitting each PSFCH communication of the second set of the plurality of PSFCH communications based on a corresponding transmission power, wherein the corresponding transmission power for a PSFCH communication of the second set of the plurality of PSFCH communications is based on one or more of: a transmission power per resource block; a number of resource blocks allocated to the PSFCH communication; the DL pathloss-based power control parameter, wherein the DL pathloss-based power control parameter indicates a P0 value, an alpha value, and a number of resource blocks allocated to the PSFCH communication.

Aspect 17. The method of any of aspects 1-16, wherein at least the second number of multi-bit PSFCH communications is based on a corresponding multi-bit priority value associated with each of the second number of multi-bit PSFCH communications, wherein at least one of the second number of multi-bit PSFCH communications comprises a plurality of bits, each bit associated with a single-bit priority value, and wherein the corresponding priority value for the at least one of the second number of multi-bit PSFCH communications is based on a smallest single-bit priority value associated with a corresponding multi-bit PSFCH communication.

Aspect 18. The method of aspects 1-16, wherein at least the second number of multi-bit PSFCH communications is based on a corresponding multi-bit priority value associated with each of the second number of multi-bit PSFCH communications, wherein at least one PSFCH communication of the second number of multi-bit PSFCH communications comprises a plurality of bits, each bit associated with a single-bit priority value, and wherein the corresponding priority value for the at least one of the second number of multi-bit PSFCH communications is based on a priority value indicated in a most recent sidelink control information (SCI) scheduling a PSSCH associated with the corresponding multi-bit PSFCH communication.

Aspect 19: A first user equipment (UE) comprising a transceiver and a processor in communication with the transceiver such that the processor and the transceiver are configured to perform the actions of any of aspects 1-18.

Aspect 20: A non-transitory, computer-readable medium having program code recorded thereon, wherein the program code comprises instructions executable by a first user equipment (UE) to case the first UE to perform the actions of any of aspects 1-18.

Aspect 21: A first user equipment (UE) comprising means for performing the actions of any of aspects 1-18.

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular embodiments illustrated and described herein, as they are merely by way of some examples thereof, but rather, should be fully commensurate with that of the aspects appended hereafter and their functional equivalents.

1. A method of wireless communication performed by a first user equipment (UE), the method comprising:
receiving, from one or more UEs, an indication to transmit a plurality of physical sidelink feedback channel (PSFCH) communications including one or more single-bit PSFCH communications and one or more multi-bit PSFCH communications; and
transmitting, to the one or more UEs based on the indication in a single PSFCH occasion, a first number of single-bit PSFCH communications of the one or more single-bit PSFCH communications, and a second number of multi-bit PSFCH communications of the one or more multi-bit PSFCH communications,
wherein the first number of single-bit PSFCH communications and the second number of multi-bit PSFCH communications are based on a PSFCH capability configuration.

2. The method of claim 1, wherein the PSFCH capability configuration indicates a maximum number of simultaneous PSFCH transmissions.

3. The method of claim 2, further comprising:
selecting, by the first UE based on the PSFCH capability configuration, a third number of single-bit PSFCH communications and a fourth number of multi-bit PSFCH communications, wherein the selecting is based on the maximum number of simultaneous PSFCH transmissions and one or more of:
a PSFCH communication ordering of the plurality of PSFCH communications;
a payload size of each of the plurality of PSFCH communications;
a cast type of each of the plurality of PSFCH communications; or
a priority of each of the plurality of PSFCH communications.

4. The method of claim 1, wherein the PSFCH capability configuration indicates a first maximum number of simultaneous single-bit PSFCH transmissions and a second maximum number of simultaneous multi-bit PSFCH transmissions.

5. The method of any of claim 4, further comprising:
selecting, by the first UE based on the PSFCH capability configuration, a third number of single-bit PSFCH communications, wherein the selecting is based on the first maximum number of simultaneous single-bit PSFCH transmissions and one or more of:
a PSFCH communication ordering of the one or more single-bit PSFCH communications;
a payload size of each of the one or more single-bit PSFCH communications
a cast type of each of the one or more single-bit PSFCH communications; or
a priority of each of the one or more single-bit PSFCH communications,
wherein the first number of single-bit PSFCH communications is based on the third number of PSFCH communications.

6. The method of any of claim 4, further comprising:
selecting, by the first UE based on the PSFCH capability configuration, a fourth number of multi-bit PSFCH communications, wherein the selecting is based on the second maximum number of simultaneous multi-bit PSFCH transmissions and one or more of:
a PSFCH communication ordering of the one or more multi-bit PSFCH communications;
a payload size of each of the one or more multi-bit PSFCH communications;
a cast type of each of the one or more multi-bit PSFCH communications; or
a priority of each of the one or more multi-bit PSFCH communications,
wherein the second number of multi-bit PSFCH communications is based on the fourth number of PSFCH communications.

7. The method of claim 1, wherein the PSFCH capability configuration indicates a first maximum number of simultaneous single-bit PSFCH transmissions and a second maximum number of simultaneous multi-bit PSFCH transmissions and a combined maximum number of simultaneous single-bit and multi-bit PSFCH transmissions.

8. The method of claim 7, further comprising:
selecting, by the first UE based on the PSFCH capability configuration, a third number of single-bit PSFCH communications, wherein the selecting is based on the first maximum number of simultaneous single-bit PSFCH transmissions and one or more of:
a PSFCH communication ordering of the one or more single-bit PSFCH communications;
a payload size of each of the one or more single-bit PSFCH communications;
a cast type of each of the one or more single-bit PSFCH communications; or
a priority of each of the one or more single-bit PSFCH communications,
wherein the first number of single-bit PSFCH communications is based on the third number of PSFCH communications.

9. The method of claim 8, further comprising:
selecting, by the first UE based on the PSFCH capability configuration, a fourth number of multi-bit PSFCH communications, wherein the selecting is based on the second maximum number of simultaneous multi-bit PSFCH transmissions and one or more of:
a PSFCH communication ordering of the one or more multi-bit PSFCH communications;
a payload size of each of the one or more multi-bit PSFCH communications;
a cast type of each of the one or more multi-bit PSFCH communications; or
a priority of each of the one or more multi-bit PSFCH communications,
wherein the second number of single-bit PSFCH communications is based on the fourth number of multi-bit PSFCH communications.

10. The method of claim 9, further comprising:
selecting, by the first UE based on the PSFCH capability configuration, a fifth number of PSFCH communications from the third number of single-bit PSFCH communications and the fourth number of multi-bit PSFCH communications, wherein the selecting is based on the combined maximum number of simultaneous single-bit and multi-bit PSFCH transmissions and one or more of:
a PSFCH communication ordering of the fifth number of PSFCH communications;
a payload size of each of the fifth number of PSFCH communications;
a cast type of each of the fifth number of PSFCH communications; or
a priority of each of the fifth number of PSFCH communications,
wherein the first number of single-bit PSFCH communications and the second number of multi-bit PSFCH communications are based on the fifth number of PSFCH communications.

11. The method of claim 1, wherein the PSFCH capability configuration indicates a maximum PSFCH transmission power parameter, and wherein the first number of single-bit PSFCH communications and the second number of multi-bit PSFCH communications are based on the maximum PSFCH transmission power parameter.

12. The method of claim 11, wherein the PSFCH capability configuration further indicates whether a downlink (DL) pathloss-based power control parameter is enabled, and wherein the first number of single-bit PSFCH communications and the second number of multi-bit PSFCH communications are based on whether the DL pathloss-based power control parameter is enabled.

13. The method of claim 12, wherein the PSFCH capability configuration indicates a first maximum number of simultaneous PSFCH transmissions, and wherein the method further comprises:
selecting, based on the first maximum number of simultaneous PSFCH communications indicated in the PSFCH capability configuration, a first set of the plurality of PSFCH communications; and
determining that the first set of PSFCH communications is equal to the first maximum number of simultaneous PSFCH transmissions,
wherein the determining is based on a total transmission power of the first set of PSFCH communications being less than or equal to the maximum PSFCH transmission power parameter.

14. The method of claim 12, further comprising:
selecting, based on at least one maximum number of simultaneous PSFCH communications indicated in the PSFCH capability configuration, a first set of the plurality of PSFCH communications; and
selecting, based on a total transmission power of the first set of the plurality of PSFCH communications exceeding the maximum PSFCH transmission power parameter, a second set of the plurality of PSFCH communications including the first number of single-bit PSFCH communications and the second number of multi-bit PSFCH communications,
wherein the selecting the second set of the plurality of PSFCH communications is based on at least one of:
a cast type of each PSFCH communication of the plurality of PSFCH communications;
a priority of each PSFCH communication of the plurality of PSFCH communications; or
a payload of each PSFCH communication of the plurality of PSFCH communications.

15. The method of claim 14, wherein a number of the second set of the plurality of PSFCH communications is equal to or larger than a lower bound.

16. The method of claim 12, further comprising:
selecting, based on at least one maximum number of simultaneous PSFCH communications indicated in the PSFCH capability configuration, a first set of the plurality of PSFCH communications; and
determining, based on a total transmission power of the first set of the plurality of PSFCH communications exceeding the maximum PSFCH transmission power parameter, a second set of the plurality of PSFCH communications including the first number of single-bit PSFCH communications and the second number of multi-bit PSFCH communications,
wherein the transmitting each PSFCH communication of the second set of the plurality of PSFCH communications comprises transmitting each PSFCH communication of the second set of the plurality of PSFCH communications based on a corresponding transmission power, wherein the corresponding transmission power for a PSFCH communication of the second set of the plurality of PSFCH communications is based on one or more of:
a transmission power per resource block;
a number of resource blocks allocated to the PSFCH communication;
the DL pathloss-based power control parameter, wherein the DL pathloss-based power control parameter indicates a P0 value, an alpha value, and a number of resource blocks allocated to the PSFCH communication.

17. The method of claim 1, wherein at least the second number of multi-bit PSFCH communications is based on a corresponding multi-bit priority value associated with each of the second number of multi-bit PSFCH communications,
wherein at least one of the second number of multi-bit PSFCH communications comprises a plurality of bits, each bit associated with a single-bit priority value, and
wherein the corresponding priority value for the at least one of the second number of multi-bit PSFCH communications is based on a smallest single-bit priority value associated with a corresponding multi-bit PSFCH communication.

18. The method of claim 1, wherein at least the second number of multi-bit PSFCH communications is based on a corresponding multi-bit priority value associated with each of the second number of multi-bit PSFCH communications,
wherein at least one PSFCH communication of the second number of multi-bit PSFCH communications comprises a plurality of bits, each bit associated with a single-bit priority value, and
wherein the corresponding priority value for the at least one of the second number of multi-bit PSFCH communications is based on a priority value indicated in a most recent sidelink control information (SCI) scheduling a PSSCH associated with the corresponding multi-bit PSFCH communication.

19. A first user equipment (UE), comprising:
a transceiver; and
a processor in communication with the transceiver such that the processor and the transceiver are configured to:
receive, from one or more UEs, an indication to transmit a plurality of physical sidelink feedback channel (PSFCH) communications including one or more single-bit PSFCH communications and one or more multi-bit PSFCH communications; and
transmit, to the one or more UEs based on the indication in a single PSFCH occasion, a first number of single-bit PSFCH communications of the one or more single-bit PSFCH communications, and a second number of multi-bit PSFCH communications of the one or more multi-bit PSFCH communications,
wherein the first number of single-bit PSFCH communications and the second number of multi-bit PSFCH communications are based on a PSFCH capability configuration.

20. The first UE of claim 19, wherein the PSFCH capability configuration indicates a maximum number of simultaneous PSFCH transmissions, and wherein the processor and the transceiver are further configured to:
select, based on the PSFCH capability configuration, a third number of single-bit PSFCH communications and a fourth number of multi-bit PSFCH communications, wherein the selecting is based on the maximum number of simultaneous PSFCH transmissions and one or more of:
a PSFCH communication ordering of the plurality of PSFCH communications;
a payload size of each of the plurality of PSFCH communications;
a cast type of each of the plurality of PSFCH communications; or
a priority of each of the plurality of PSFCH communications.

21. The first UE of claim 19, wherein the PSFCH capability configuration indicates a first maximum number of simultaneous single-bit PSFCH transmissions and a second maximum number of simultaneous multi-bit PSFCH transmissions, and wherein the processor and the transceiver are further configured to:
select, based on the PSFCH capability configuration, a third number of single-bit PSFCH communications, wherein the selecting is based on the first maximum number of simultaneous single-bit PSFCH transmissions and one or more of:
a PSFCH communication ordering of the one or more single-bit PSFCH communications;
a payload size of each of the one or more single-bit PSFCH communications
a cast type of each of the one or more single-bit PSFCH communications; or
a priority of each of the one or more single-bit PSFCH communications,
wherein the first number of single-bit PSFCH communications is based on the third number of PSFCH communications.

22. The first UE of claim 22, wherein the processor and the transceiver are further configured to:
select, based on the PSFCH capability configuration, a fourth number of multi-bit PSFCH communications, wherein the selecting is based on the second maximum number of simultaneous multi-bit PSFCH transmissions and one or more of:
a PSFCH communication ordering of the one or more multi-bit PSFCH communications;
a payload size of each of the one or more multi-bit PSFCH communications
a cast type of each of the one or more multi-bit PSFCH communications; or
a priority of each of the one or more multi-bit PSFCH communications,
wherein the first number of multi-bit PSFCH communications is based on the third number of PSFCH communications.

23. The first UE of claim 19, wherein the PSFCH capability configuration indicates a first maximum number of simultaneous single-bit PSFCH transmissions and a second maximum number of simultaneous multi-bit PSFCH transmissions and a combined maximum number of simultaneous single-bit and multi-bit PSFCH transmissions.

24. The first UE of claim 19, wherein the PSFCH capability configuration indicates a maximum PSFCH transmission power parameter, and wherein the first number of single-bit PSFCH communications and the second number of multi-bit PSFCH communications are based on the maximum PSFCH transmission power parameter.

25. The first UE of claim 24, wherein the PSFCH capability configuration further indicates whether a downlink (DL) pathloss-based power control parameter is enabled, and wherein the first number of single-bit PSFCH communications and the second number of multi-bit PSFCH communications are based on whether the DL pathloss-based power control parameter is enabled.

26. The first UE of claim 25, wherein the processor and the transceiver are further configured to:
select, based on at least one maximum number of simultaneous PSFCH communications indicated in the PSFCH capability configuration, a first set of the plurality of PSFCH communications; and
select, based on a total transmission power of the first set of the plurality of PSFCH communications exceeding the maximum PSFCH transmission power parameter, a second set of the plurality of PSFCH communications including the first number of single-bit PSFCH communications and the second number of multi-bit PSFCH communications,
wherein the selecting the second set of the plurality of PSFCH communications is based on at least one of:
a cast type of each PSFCH communication of the plurality of PSFCH communications;
a priority of each PSFCH communication of the plurality of PSFCH communications; or
a payload of each PSFCH communication of the plurality of PSFCH communications.

27. The first UE of claim 19, wherein at least the second number of multi-bit PSFCH communications is based on a corresponding multi-bit priority value associated with each of the second number of multi-bit PSFCH communications,
wherein at least one of the second number of multi-bit PSFCH communications comprises a plurality of bits, each bit associated with a single-bit priority value, and
wherein the corresponding priority value for the at least one of the second number of multi-bit PSFCH communications is based on a smallest single-bit priority value associated with a corresponding multi-bit PSFCH communication.

28. The first UE of claim 19, wherein at least the second number of multi-bit PSFCH communications is based on a corresponding multi-bit priority value associated with each of the second number of multi-bit PSFCH communications,
wherein at least one PSFCH communication of the second number of multi-bit PSFCH communications comprises a plurality of bits, each bit associated with a single-bit priority value, and
wherein the corresponding priority value for the at least one of the second number of multi-bit PSFCH communications is based on a priority value indicated in a most recent sidelink control information (SCI) scheduling a PSSCH associated with the corresponding multi-bit PSFCH communication.

29. A non-transitory, computer readable medium having program code recorded thereon, wherein the program code comprises instructions executable by a first user equipment (UE) to cause the first UE to:
receive, from one or more UEs, an indication to transmit a plurality of physical sidelink feedback channel (PSFCH) communications including one or more single-bit PSFCH communications and one or more multi-bit PSFCH communications; and
transmit, to the one or more UEs based on the indication in a single PSFCH occasion, a first number of single-bit PSFCH communications of the one or more single-bit PSFCH communications, and a second number of multi-bit PSFCH communications of the one or more multi-bit PSFCH communications,
wherein the first number of single-bit PSFCH communications and the second number of multi-bit PSFCH communications are based on a PSFCH capability configuration.

30. A first user equipment (UE), comprising:
means receiving, from one or more UEs, an indication to transmit a plurality of physical sidelink feedback channel (PSFCH) communications including one or more single-bit PSFCH communications and one or more multi-bit PSFCH communications; and
means transmitting, to the one or more UEs based on the indication in a single PSFCH occasion, a first number of single-bit PSFCH communications of the one or more single-bit PSFCH communications, and a second number of multi-bit PSFCH communications of the one or more multi-bit PSFCH communications,
wherein the first number of single-bit PSFCH communications and the second number of multi-bit PSFCH communications are based on a PSFCH capability configuration.
